(19) United States
(12) Patent Application Publication
(10) Pub. No.: US 2023/0405556 A1
(43) Pub. Date: Dec. 21, 2023

(54) CoNiFe OXIDE NANOSTRUCTURED CATALYSTS, AND USES THEREOF

(71) Applicants: University of Guelph, Guelph (CA); Tecmerra Methane Solutions Inc., Winnipeg (CA)

(72) Inventors: Aicheng Chen, Guelph (CA); Libin Zeng, Guelph (CA); Antony R. Thiruppathi, Guelph (CA); Joshua van der Zalm, Guelph (CA); Tony Shi, Guelph (CA)

(21) Appl. No.: 18/210,798

(22) Filed: Jun. 16, 2023

Related U.S. Application Data
(60) Provisional application No. 63/353,182, filed on Jun. 17, 2022.

(51) Int. Cl. B01J 23/00; B01J 21/18; B01J 35/00; B01J 35/02; C25B 3/07; C25B 11/077

(52) U.S. Cl. CPC B01J 23/002; B01J 21/18; B01J 35/0033; B01J 35/026; B01J 35/023; C25B 3/07; C25B 11/077

(57) ABSTRACT

The present disclosure is directed to CoNiFe nanostructured catalysts, and the use of such catalysts in the electrochemical conversion of methane to methanol. In particular, the present disclosure is directed to nanocube catalysts having the formula Co₁₋ₓNiₓFe₂O₄.

### CROSS-REFERENCE TO RELATED APPLICATIONS

This application claims the benefit of priority to U.S. Provisional Application No. 63/353,182, filed Jun. 17, 2022, the contents of which is incorporated herein by reference in its entirety.

### FIELD

The present disclosure is directed to CoNiFe nanostructured catalysts, and the use of such catalysts in the electrochemical conversion of methane to methanol. In particular, the present disclosure is directed to nanocube catalysts having the formula Co₁₋ₓNiₓFe₂O₄.

### INTRODUCTION

Methane (CH₄) is not only the second most prominent greenhouse gas¹ that contributes to global warming, but also a potentially useful feedstock which can be converted to valuable products for the chemical industry.²⁻⁴ Given ever-worsening environmental issues and the inevitable depletion of fossil fuel for energy, the development of efficient and eco-friendly strategies for improving direct methane conversion (DMC) to value-added chemicals are urgently required.⁵⁻⁷ The traditional Fischer-Tropsch method for methanol synthesis depends primarily on the transformation of syngas (a mixture of CO and H₂) to useful chemicals through energy-intensive reactions, which makes it economically and environmentally prohibitive.⁸ Furthermore, the C—H activation of CH₄ molecule and over-oxidation of products also largely limits the conversion kinetics and the selectivity of CH₄ oxidation.² Thus, it is critical to develop highly active catalysts with tunable selectivity for the efficient conversion of CH₄. In recent years, the conversion of CH₄ to oxygenates has garnered a high level of interest for resource management and carbon capture. Consequently, numerous alternative strategies have been explored toward the development of DMC technologies using liquid-phase reactions that involve catalysis,⁹ enzyme catalysis,¹⁰ biocatalysis,¹¹ photocatalysis,⁸ and electrocatalysis.¹² Due to their low cost, controllable reactions, and easy scale-up, electrocatalytic CH₄ oxidation provides an attractive, environmentally friendly approach for the efficacious generation of valuable chemical products. Efficient electrocatalysts for the conversion of CH₄ are essential to improve the thermodynamic and kinetics of the process in contrast to the competing oxygen evolution reaction (OER).

Great efforts have been devoted to the exploration of high-performance electrocatalysts,^{13, 14} electrochemical reaction cell designs,^{15, 16} the incorporation of microbes^{11, 17} or solar cells,^{18, 19} and density functional theory (DFT) calculation techniques^{20, 21} to promote the conversion of CH₄ and its utilization under ambient conditions. Despite the significant advance in the field of CH₄ conversion to date, one of the great challenges that remain towards the optimal oxidation of CH₄ is the design of highly active electrocatalysts for C—H activation and product selectivity. In this regard, the development of effective electrocatalysts for the DMC to oxygenates is a critical prerequisite.

### SUMMARY

The present disclosure is directed to CoNiFe nanostructured catalysts, and the use of such catalysts in the electrochemical conversion of methane to methanol. In particular, the present disclosure is directed to nanocube catalysts having the formula Co₁₋ₓNiₓFe₂O₄.

In one embodiment of the disclosure, there is included an electrochemical catalyst, comprising:
(a) a trimetallic oxide of the formula

Co₁₋ₓNiₓFe₂O₄
wherein the catalyst is in the form of nano-cubes; and
(b) carbon.

In one embodiment, the electrochemical catalysts of the present disclosure are used for the electrochemical oxidation of methane

In one embodiment of the disclosure, there is included a method for preparing methanol from methane in an electrochemical process, the process comprising;
(a) introducing methane into an anode chamber of an electrochemical reactor, wherein the anode chamber comprises an anode comprising the electrochemical catalyst of the disclosure;
(b) introducing a catholyte into a cathode chamber of the electrochemical reactor, wherein the cathode chamber comprises a cathode;
(c) introducing a voltage across the anode and the cathode, whereby at least a portion of the methane is oxidized to methanol; and
(d) collecting the methanol from the anode chamber.

Other features and advantages of the present application will become apparent from the following detailed description. It should be understood, however, that the detailed description and the specific examples while indicating preferred embodiments of the application are given by way of illustration only, since various changes and modifications within the spirit and scope of the application will become apparent to those skilled in the art from this detailed description.

### BRIEF DESCRIPTION OF THE DRAWINGS

The present disclosure will now be described in greater detail with reference to the drawings in which:

FIG. 1 is an (a) SEM image and (b) corresponding size distributions of NiFe PBA template catalyst; (c) Thermogravimetry curve of the NiFe PBA template under air conditions at heating rate of 2° C. min⁻¹; (d) Image of the different ratios of CoNiFe—N/C catalyst inks, in one embodiment of the disclosure.

FIG. 2. Are SEM images of Co_{y}Ni_{1-y}—Fe₂O₄—N/C catalysts, (a) y=0, (b) y=0.2, (c) y=0.4, (d) y=0.6, (e) y=0.8, and (f) y=1, respectively

FIG. 3 are SEM images of Co_{y}Ni_{1-y}—Fe₂O₄—N/C catalysts, (a) y=0, (b) y=0.2, (c) y=0.4, (d) y=0.6, (e) y=0.8, and (f) y=1, respectively, in one embodiment of the disclosure.

FIG. 4 are SEM images of Co_{y}Ni_{1-y}—Fe₂O₄ catalysts, (a) y=0, (b) y=0.2, (c) y=0.4, (d) y=0.6, (e) y=0.8, and (f) y=1, respectively, in one embodiment of the disclosure.

FIG. 5 shows (a) Average size of Co_{y}Ni_{1-y}—Fe₂ PBA derived catalysts under Air- and Ar-conditions, respectively; (b) Scheme of the structure proposed for the PBA particles in CoFeNi, in one embodiment of the disclosure. The scale between the core and the shell is arbitrary.

FIG. 6 are (a)-(b) LSV curves of CoNiFe—N/C-0.8 and CoNiFe-8 in Ar- and N₂-saturated 0.1 M Na₂SO₄ solution, respectively; (c)-(d) LSV curves of CoNiFe—N/C-0.6 and CoNiFe-0.6 in Ar- and CH₄-saturated 0.5 M Na₂CO₃ solution, respectively, in one embodiment of the disclosure. Scan rate: 20 mV s⁻¹.

FIG. 7 are (a)-(e) LSV curves of CoNiFe—N/C-x (x=0, 0.2, 0.4, 0.6, 1) catalysts in Ar- and N₂-saturated 0.1 M Na₂SO₄ solution with a scan rate of 20 mV s⁻¹, respectively. (f) the corresponding current density difference of the CoNiFe—N/C catalysts measured at the N₂-saturated and the Ar-saturated solution, in one embodiment of the disclosure.

FIG. 8 are (a)-(e) LSV curves of CoNiFe-x (x=0, 0.2, 0.4, 0.6, 1) catalysts in Ar- and N₂-saturated 0.1 M Na₂SO₄ solution with a scan rate of 20 mV s⁻¹, respectively. (f) the corresponding current density difference of the CoNiFe-x catalysts measured at the N₂-saturated and the Ar-saturated solution, in one embodiment of the disclosure.

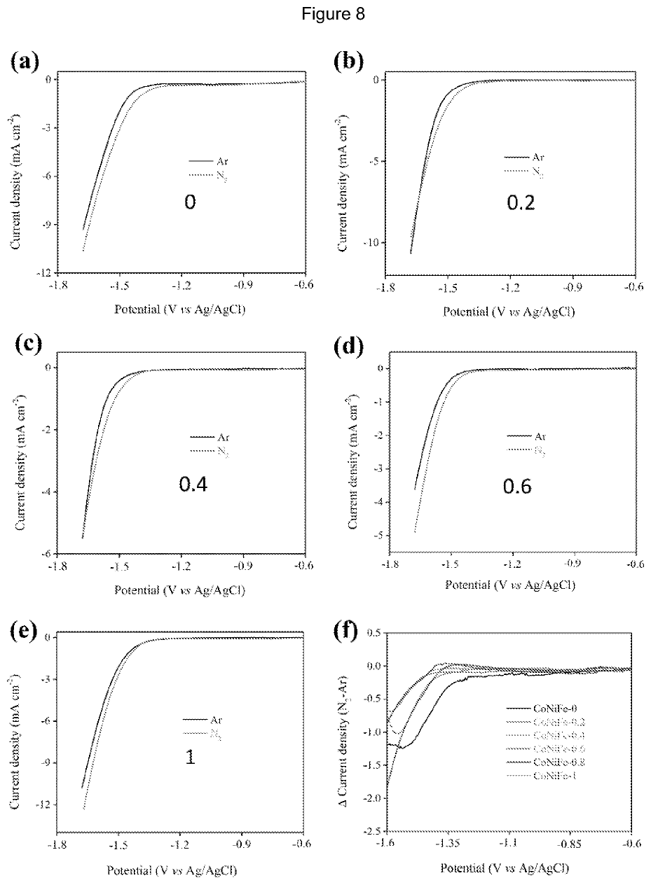

FIG. 9 are (a)-(e) LSV curves of CoNiFe—N/C-x (x=0, 0.2, 0.4, 0.8, 1) catalysts in Ar- and CH₄-saturated 0.5 M Na₂CO₃ solution with a scan rate of 20 mV s⁻¹, respectively. (f) current density difference of the CoNiFe—N/C-x catalysts measured at the CH₄-saturated and the Ar-saturated solution, in one embodiment of the disclosure.

FIG. 10 are (a)-(e) LSV curves of CoNiFe-x (x=0, 0.2, 0.4, 0.8, 1) catalysts in Ar- and CH₄-saturated 0.5 M Na₂CO₃ solution with a scan rate of 20 mV s⁻¹, respectively. (f) the current density difference of the CoNiFe-x catalysts measured at the CH₄-saturated and the Ar-saturated solution, in one embodiment of the disclosure.

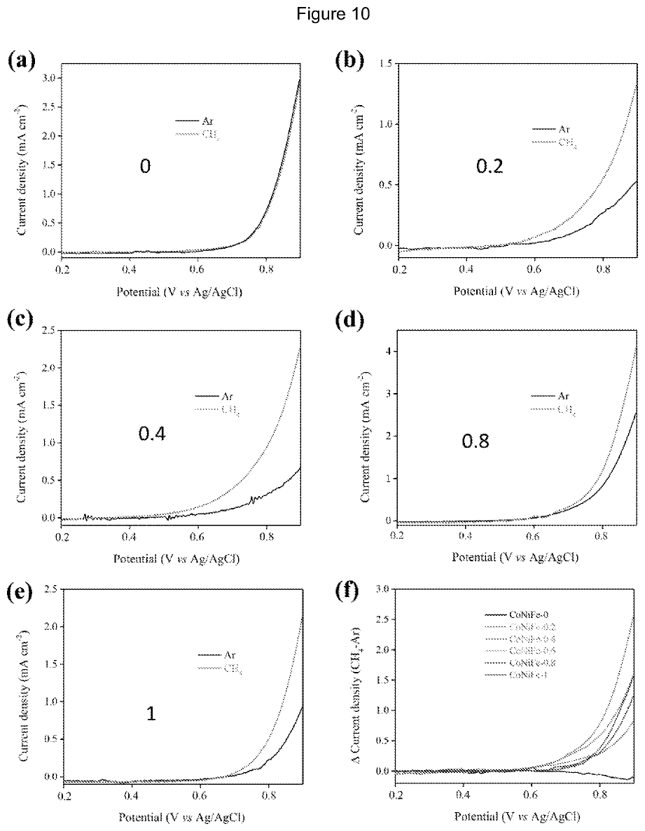

FIG. 11 are Co_{0.6}Ni_{0.4}—Fe₂O₄—N/C catalyst: (a) TEM image; (b) HRTEM image; (c) TEM mappings. Co_{0.8}Ni_{0.2}—Fe₂O₄—N/C catalyst: (d) TEM image; (e) HRTEM image; (f) TEM mappings.

FIG. 12 are constructed crystal structures of (a) bulk Co_{y}Ni_{1-y}Fe₂O₄, (b) Co_{y}Ni_{1-y}Fe₂O₄—CH₃, (c) Co_{y}Ni_{1-y}Fe₂O₄—N₂, (d) Co_{y}Ni_{1-y}Fe₂O₄—N/C and (e) Co_{y}Ni_{1-y}Fe₂O₄—N/C—CH₃, (e) Co_{y}Ni_{1-y}Fe₂O₄—N/C—N₂

FIG. 13 are simulated XRD patterns of built crystalline Co_{y}Ni_{1-y}Fe₂O₄ (a) and Co_{y}Ni_{1-y}Fe₂O₄—N/C (b) models, in one embodiment of the disclosure.

FIG. 14 are (a) XRD patterns and (b) Raman spectra of the as-prepared CoNiFe—N/C-x catalysts.

FIG. 15 are XPS survey scans of the as-prepared CoNiFe—N/C-x catalysts, x refers to the content of Co replacement of Ni atoms; High-resolution XPS spectra of CoNiFe—N/C-x catalysts for Co 2p (b), Ni 2p (c), Fe 2p (d), C 1s (e) and N 1s (f)

FIG. 16 are high-resolution XPS spectra of CoNiFe—N/C-x catalysts for N 1s, in one embodiment of the disclosure.

FIG. 17 are (a) Contents distribution of nitrogen species of CoNiFe—N/C-x catalysts; High-resolution XPS spectra of CoNiFe—N/C-x catalysts for O 1s (b) and the corresponding oxygen species distribution (c); (d) Oₗₐₜₜ/O_{V} ratios of the CoNiFe—N/C-x catalysts.

FIG. 18 are high-resolution XPS spectra of CoNiFe—N/C-x catalysts for O 1s, in one embodiment of the disclosure.

FIG. 19 are EIS spectra of: (a) Co_{0.8}Ni_{0.2}Fe₂O₄—N/C catalyst under the Ar- and N₂-saturated conditions; (b) various composition ratios of the CoNiFe—N/C catalysts under the N₂-saturation condition [Inset: equivalent circuit model (Point: original data; Line: fitting data)]; (c) the Co_{0.6}Ni_{0.4}Fe₂O₄—N/C catalyst under the Ar- and CH₄-saturated conditions; (d) various composition ratios of the CoNiFe—N/C catalysts under CH₄-saturation conditions, in one embodiment of the disclosure [Inset: equivalent circuit model].

FIG. 20 are ECSA comparisons for (a) CoNiFe—N/C-0.4, (b) 0.6, (c) 0.8 composites based on their double-layer capacitances using CV at different scan rates from 10 to 100 mV s⁻¹ in N₂-saturated 0.1 M Na₂SO₄. (d) the corresponding plots of the current density at −0.75 V vs. the scan rate, in one embodiment of the disclosure.

FIG. 21 are ECSA comparisons for (a) CoNiFe—N/C-0.4, (b) 0.6, (c) 0.8 composites based on their double-layer capacitances using CV at different scan rates from 10 to 100 mV s⁻¹ in CH₄-saturated 0.5 M Na₂CO₃. (d) the corresponding plots of the current density at 1.0 V vs. the scan rate, in one embodiment of the disclosure.

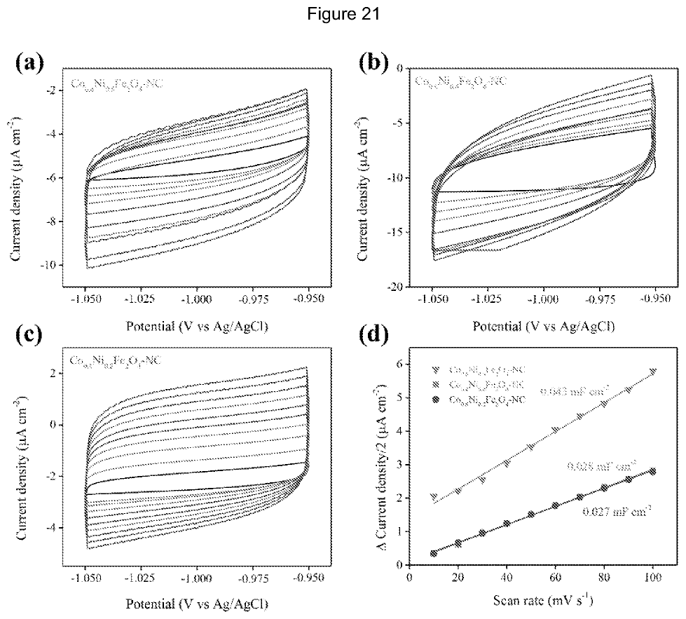

FIG. 22 are chronoamperometric curves for the NRR recorded at different potentials over the CoNiFe—NC-0.8 catalyst, in one embodiment of the disclosure.

FIG. 23 show (a) NH₃ yields and the corresponding FEs of CoNiFe—N/C-0.8 after two-hour electrolysis at the different potentials; NH₃ yields and the corresponding FEs of CoNiFe—N/C-x (b) and CoNiFe-x (c) after two-hour electrolysis at −1.4 V vs Ag/AgCl, respectively; Products analysis under different potentials of the electrochemical CH₄ oxidation at Co_{0.6}Ni_{0.4}Fe₂O₄—N/C in the anode chamber: (d)¹H-NMR spectrum of the products after two-hour electrolysis; (e) Products yield and FE (f) of methanol and 2-propanol; (g) Illustration of the integrated electrochemical system for the simultaneous CH₄ oxidation and N₂ reduction; (h) Anode current density of the CH₄ oxidation with or without the NRR in the cathode chamber; (i) Chronoamperometric curves of the cathode chamber for the NRR at −0.8 V vs Ag/AgCl, in one embodiment of the disclosure.

FIG. 24 are (a) Calibration curve for the detection of N₂H₄ concentration; (b) UV-vis spectra of the cathode chamber solution after two-hour electrolysis under an Ar- and N₂-saturated condition, in one embodiment of the disclosure.

FIG. 25 are product yield percentage of the DMC over the Co_{0.6}Ni_{0.4}Fe₂O₄—N/C catalyst at different applied potentials, in one embodiment of the disclosure.

FIG. 26 are EPR spectra of the electrochemical CH₄ oxidation over the Co_{0.6}Ni_{0.4}Fe₂O₄—N/C catalyst (DMPO—·O₂— formed in methanol dispersions, 0.3 M; Blue (middle): open voltage condition; Red (top): with potential), in one embodiment of the disclosure.

FIG. 27 are adsorption energy comparison of the CH₄ absorption over the surface of CoNiFe-x and CoNiFe—N/C-x catalysts, in one embodiment of the disclosure.

FIG. 28 are PDOS of (a) Co_{0.6}Ni_{0.4}Fe₂O₄—N/C and (b) Co_{0.8}Ni_{0.2}Fe₂O₄—N/C surface; (c) & (d) corresponding PDOS of CH₄ and N₂ adsorption, respectively, in one embodiment of the disclosure. (Inset shows the electron density difference between these four optimized structures, blue region: electron rich; red region: electron deficit).

FIG. 29 are PDOS of carbon layer for (a) Co_{0.6}Ni_{0.4}Fe₂O₄—NC and (b) Co_{0.6}Ni_{0.4}Fe₂O₄—NC surface, and the corresponding CH₄ adsorption (c) and N₂ adsorption (d) in one embodiment of the disclosure.

FIG. 30 is a schematic representation showing different Co/Ni ratio regulation and the thermal conversion of Co_{y}Ni_{1-y}Fe-PBA at 350° C. under Ar conditions, the CN— groups of the PBA were converted into the N-doping carbon layer (N/C), where Co, Ni and Fe species were transformed to CoNiFe oxides, in an embodiment of the disclosure.

FIG. 31 is a schematic representation showing the possible mechanism of the combined electrochemical system in an embodiment of the disclosure.

### DESCRIPTION OF VARIOUS EMBODIMENTS

### (I) Definitions

Unless otherwise indicated, the definitions and embodiments described in this and other sections are intended to be applicable to all embodiments and aspects of the present application herein described for which they are suitable as would be understood by a person skilled in the art.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

The term “consisting” and its derivatives, as used herein, are intended to be closed terms that specify the presence of the stated features, elements, components, groups, integers, and/or steps, but exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this application, the singular forms “a”, “an” and “the” include plural references unless the content clearly dictates otherwise.

In embodiments comprising an “additional” or “second” component, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “nanocube” as used herein refers to the structural atomic arrangement of the trimetallic oxide in cube-like form having dimensions having nanoscale dimensions, for example, about 10 nanometers to 1 micrometer.

The term “carbon” as used herein includes both non-graphitic and graphitic forms of carbon.

The term “adjacent” as used herein, when referring to the carbon layer and the nano-cubes, means that the two are in proximity with one another with little or no intervening open space.

The term “layer” as used herein refers to a layer of carbon atoms or molecules on a substrate which is adjacent or near the trimetallic oxide nano-cubes.

### (II) Electrochemical Catalysts

The present disclosure is directed to highly active electrochemical catalysts for the efficient conversion of methane to methanol. In addition, the same catalysts are useful for the conversion of nitrogen gas to ammonia.

Accordingly, in one embodiment, the present disclosure is directed to an electrochemical catalyst, comprising:
(i) a trimetallic oxide of the formula

Co₁₋ₓNiₓFe₂O₄
wherein the catalyst is in the form of nano-cubes; and
(ii) carbon.

In one embodiment, the trimetallic oxide is Co_{0.8}Ni_{0.2}Fe₂O₄.

In one embodiment, the trimetallic oxide is Co_{0.6}Ni_{0.4}Fe₂O₄.

In one embodiment, the catalyst has XRD peaks of 18.28°, 26.15°, 35.69° and 43.36°.

In a further embodiment, x is an integer between 0.01 and 0.99, or 0.1 to 0.9.

In another embodiment, x is about 0.20, about 0.40, about 0.60, or about 0.80.

In one embodiment, the carbon is elemental carbon. In one embodiment, the carbon may contain other atoms such as oxygen or nitrogen which do not affect the catalytic activity of the electrochemical catalysts of the disclosure.

In another embodiment, the elemental carbon is graphite or graphene.

In one embodiment, the carbon is in the form of a layer adjacent to the nano-cube.

In one embodiment, the carbon, optionally in the form of a layer, is a structure of carbon atoms which are held together by covalent, ionic or other strong intramolecular forces. Layers may be planar or contoured. In one embodiment, there are more than one carbon layers which may be held together via intermolecular forces, such as van der Waals interactions. Examples of carbon layers include, but are not limited to, graphite layers, graphene sheets, and carbon films. A carbon layer may also refer to a carbonaceous coating the outer surface of the nanocube.

In one embodiment, the dimensions of the nanocubes with the adjacent carbon layer is between 10 nm and 1000 nm

In one embodiment, the dimensions of the nanocubes with the adjacent carbon layer is between 500 nm and 700 nm.

In one embodiment, the dimensions of the nanocubes with the adjacent carbon layer is between 600 nm and 700 nm.

In one embodiment, the dimensions of the nanocubes with the adjacent carbon layer is between 640 nm.

### (III) Electrochemical Processes

The present disclosure is directed to electrochemical catalysts for the efficient conversion of methane to methanol, and also of nitrogen gas to ammonia. Accordingly, in one embodiment of the disclosure, there is included a method for preparing methanol from methane in an electrochemical process, the process comprising;
(a) introducing methane into an anode chamber of an electrochemical reactor, wherein the anode chamber comprises an anode comprising the electrochemical catalyst of the disclosure;
(b) introducing a catholyte into a cathode chamber of the electrochemical reactor, wherein the cathode chamber comprises a cathode;
(c) introducing a voltage across the anode and the cathode, whereby at least a portion of the methane is oxidized to methanol; and
(d) collecting the methanol from the anode chamber

In another embodiment, the process further produces isopropanol.

In one embodiment, the electrochemical catalyst is Co_{0.6}Ni_{0.4}Fe₂O₄.

In one embodiment, the voltage is between 0.5 V and 1.5 V.

In one embodiment, the present disclosure is also directed to a method for preparing ammonia from nitrogen gas (N₂) in an electrochemical process, the process comprising;
(a) introducing ammonia into a cathode chamber of an electrochemical reactor, wherein the cathode chamber comprises a cathode comprising the electrochemical catalyst of the disclosure;
(b) introducing an anolyte into am anode chamber of the electrochemical reactor, wherein the anode chamber comprises an anode;
(c) introducing a voltage across the anode and the cathode, whereby at least a portion of the nitrogen gas is reduced to ammonia; and
(d) collecting the ammonia from the cathode chamber

In another embodiment, the electrochemical catalyst is Co_{0.8}Ni_{0.2}Fe₂O₄.

In one embodiment, the voltage is between 0.5 V and 1.5 V.

In another embodiment, the catalysts of the present disclosure are dual use and are useful as anodes and cathodes in an electrochemical process for preparing methanol from methane and ammonia from nitrogen gas in an electrochemical process, the process comprising;
(a) introducing methane into an anode chamber of an electrochemical reactor, wherein the anode chamber comprises an anode comprising the electrochemical catalyst of the disclosure;
(b) introducing ammonia into a cathode chamber of an electrochemical reactor, wherein the cathode chamber comprises a cathode comprising the electrochemical catalyst of the disclosure;
(c) introducing a voltage across the anode and the cathode, whereby at least a portion of the methane in the anode chamber is oxidized to methanol and at least a portion of the nitrogen gas is reduced to ammonia in the cathode chamber; and
(d) collecting the methanol from the anode chamber and the ammonia from the cathode chamber

In one embodiment, the electrochemical catalyst in the anode chamber is 000.6Ni_{0.4}Fe₂O₄.

In one embodiment, the electrochemical catalyst in the cathode chamber is Co_{0.8}Ni_{0.2}Fe₂O₄.

In one embodiment, the voltage is between 0.5 V and 1.5 V

Although the disclosure has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present disclosure.

### EXAMPLES

The operation of the disclosure is illustrated by the following representative examples. As is apparent to those skilled in the art, many of the details of the examples may be changed while still practicing the disclosure described herein.

Experimental Section

Chemicals

Nickel (II) nitrate hexahydrate (99%, Ni(NO₃)₂·6H₂O), cobalt (II) nitrate hexahydrate (98%, Co(NO₃)₂·6H₂O), sodium citrate (99%, Na₃C₆H₅O₇), potassium hexacyanoferrate (III) (99%*, K₄Fe(CN)₆), sodium sulfate (99%, Na₂SO₄), sodium carbonate (99%*, Na₂CO₃), sodium hydroxide (97%*, NaOH), sodium salicylate (99%, C₇H₅O₃Na), sodium hypochlorite (5%, NaClO), sodium nitroferricyanide (III) (99%*, C₅FeN₆Na₂O), hydrazine (98%*, N₂H₄), and ammonium chloride (99%*, NH₄Cl) were purchased from Sigma-Aldrich Chemical Reagent Ltd. Nafion (1 wt. %) solution, hydrogen peroxide (30%, H₂O₂), sulfuric acid (99%*), methanol and ethanol were purchased from Aladdin Ltd. All reagents were of analytical grade and used without further purification. Additionally, an anion exchange membrane (AEM) was purchased from the DuPont Company (N2050TX, thickness: 0.3 mm). The deionized (DI) water (18.2 MΩcm) used in all experiments was obtained from a Nanopure Diamond™ ultrapure water system.

Synthesis of NiFe PBA NCs template: Uniform Ni—Fe PBA nanocubes (NCs) were synthesized via our previously reported method.⁴ In a typical procedure, 6 mmol of Ni(NO₃)₂·6H₂O and 9 mmol of Na₃C₆H₅O₇ were dissolved in 200 mL of deionized (DI) water to form solution A. Simultaneously, 4 mmol of K₄Fe(CN)₆ was dissolved in another 200 mL of DI water to form solution B. Subsequently, solution B was added drop-by-drop into solution A under magnetic stirring for 20 min. After that, the mixed solution was aged at room temperature for 24 h. The following collection by centrifugation and washed with water and ethanol, the precipitate was dried at 60° C. overnight.

Synthesis of NiFe₂O₄ and NiFe₂O₄—N/C NCs: Two as-prepared NiFe PBA samples (200 mg each) were further pyrolyzed at 350° C. under Air and Ar atmosphere for 2 h at a heating rate of 2° C. min⁻¹, respectively. After cool down, 110.8 mg and 112.4 mg were obtained, which were ascribed to NiFe₂O₄ and NiFe₂O₄—N/C NCs, respectively. The catalyst-carbonized yield was calculated as follows:

Yield of catalyst (%)=(m_{Carbonization}/m_{Catalyst precursor})*100%

Preparation of CoNiFe-x PBA NCs templates: CoNiFe-x PBA nanocubes (NCs) were synthesized using the same method as the synthesis of NiFe PBA. In a typical route, the content of Co was used to replace the Ni ions in the NiFe PBA, such that the total Co and Ni precursors were 6 mmol, where x refers to the Co contents (x=0.2, 0.4, 0.6, 0.8). For example, to prepare the sample with x=0.2, 4.8 mmol of Ni(NO₃)₂·6H₂O, 1.2 mmol of Co(NO₃)₂·6H₂O and 9 mmol of Na₃C₆H₅O₇ were dissolved in 200 mL of DI water to form Solution A. Meanwhile, 4 mmol of K₄Fe(CN)₆ was dissolved in another 200 mL of DI water to form Solution B. Subsequently, Solution B was added dropwise into Solution A under magnetic stirring for 20 min. After that, the mixed solution was aged at room temperature for 24 h. The precipitate was separated and purified through centrifugation and washing with DI water and ethanol; it was then dried at 60° C. overnight to obtain the CoNiFe-0.2 PBA NCs, CoNiFe-0.4 PBA NCs, CoNiFe-0.6 PBA NCs and CoNiFe-0.8 PBA NCs samples.

Synthesis of Co_{y}Ni_{1-y}Fe₂O₄ and Co_{y}Ni_{1-y}Fe₂O₄—N/C NCs: Two of the as-prepared CoNiFe-x PBA NCs (200 mg each) were further pyrolyzed at 350° C. under Air and Ar atmosphere for 2 h at a heating rate of 2° C. min⁻¹, respectively. After cooling, 121.8 mg, 134.2 mg, 130 mg and 122.2 mg were obtained under the air atmosphere, which was ascribed to Co_{0.2}Ni_{0.8}Fe₂O₄ NCs, Co_{0.4}Ni_{0.6}Fe₂O₄ NCs, Co_{0.6}Ni_{0.4}Fe₂O₄ NCs and Co_{0.8}Ni_{0.2}Fe₂O₄ NCs, respectively. Simultaneously, under the Ar atmosphere, 144.2 mg, 154.2 mg, 134.6 mg and 127.2 mg, corresponded to Co_{0.2}Ni_{0.8}Fe₂O₄—N/C NCs, Co_{0.4}Ni_{0.6}Fe₂O₄—N/C NCs, Co_{0.6}Ni_{0.4}Fe₂O₄—N/C NCs and Co_{0.8}Ni_{0.2}Fe₂O₄—N/C NCs, respectively.

Preparation of CoFe PBA NCs template: CoFe PBA nanocubes (NCs) were prepared using the same method as the synthesis of NiFe PBA. 6 mmol of Co(NO₃)₂·6H₂O and 9 mmol of Na₃C₆H₅O₇ were dissolved in 200 mL of DI water to form Solution A. Meanwhile, 4 mmol of K₄Fe(CN)₆ was dissolved in another 200 mL of DI water to form Solution B. Afterwards, Solution B was added dropwise into Solution A under magnetic stirring for 20 min. After that, the mixed solution was aged at room temperature for 24 h. The following collection was made by centrifugation and washing with water and ethanol; the precipitates were dried at 60° C. overnight, and the obtained sample was named as CoFe PBA NCs.

Synthesis of CoFe₂O₄ and CoFe₂O₄—N/C NCs: Two of the as-prepared CoFe PBA NCs (200 mg) were further pyrolyzed at 350° C. under Air and Ar atmosphere for 2 h at a heating rate of 2° C. min⁻¹, respectively. After cooling, 107.8 mg and 124.2 mg were obtained, which were ascribed to CoFe₂O₄ and CoFe₂O₄—N/C NCs, respectively.

Electrochemical measurements: The electrochemical characterization of the as-prepared Co_{y}Ni_{1-y}Fe₂O₄—N/C and Co_{y}Ni_{1-y}Fe₂O₄—N/C catalysts was carried out in a single cell (30 mL) with the required gas inflow systems using an electrochemical workstation (Voltalab Potentiostat PGZ301). Each as-prepared 5 mg sample was dispersed in a mixed 480 μL ethanol, 480 μL water and 40 μL Nafion (0.5 wt. %) solution under continuous sonication for 60 min. The obtained catalyst inks (10 μL) were coated onto a well-polished and cleaned glassy carbon electrode (03 mm, 0.071 cm²) as the working electrodes. A saturated Ag/AgCl and graphite rod (03 mm) were used as the reference and counter electrodes, respectively. For the nitrogen reduction reaction (NRR), before the electrochemical experiment, ultra-pure nitrogen gas (99.999%) was purged into the electrolyte solution for at least 20 min to achieve saturation. 0.1 M Na₂SO₄ solution was chosen as the electrolyte for all electrochemical nitrogen reduction experiments. To test the CH₄ oxidation activity, ultra-pure CH₄ gas (99.999%) was purged into a 0.5 M Na₂CO₃ solution, which was used as the electrolyte for the CH₄ oxidation reaction. To assess the hydrogen evolution behavior and other interferences, measurements were carried out under the argon-saturated and open potential conditions, respectively.

Linear sweep voltammetry (LSV) was employed to evaluate the catalytic activity under Ar-, N₂- and CH₄-saturated conditions (sweep rate: 20 mV s⁻¹). To determine the electrochemical surface area (ECSA) of these catalysts, the cyclic voltammograms (CVs) of these electrocatalysts were recorded in the double-layer region at different scan rates (10, 20, 30, 40, 50, 60, 70, 80, 90, 100 mV s⁻¹) under different conditions for the NRR (electrolyte: 0.1 M Na₂SO₄) and for the CH₄ oxidation (electrolyte: 0.5 M Na₂CO₃), respectively. The charge transfer resistance for the NRR and DMC was investigated using electrochemical impedance spectroscopy (EIS) (10⁻²-10⁵ Hz). All experiments were performed at room temperature (20±2° C.).

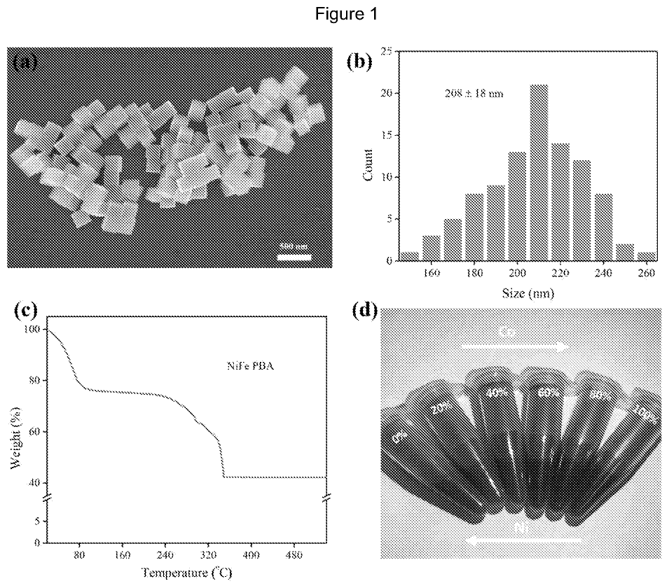

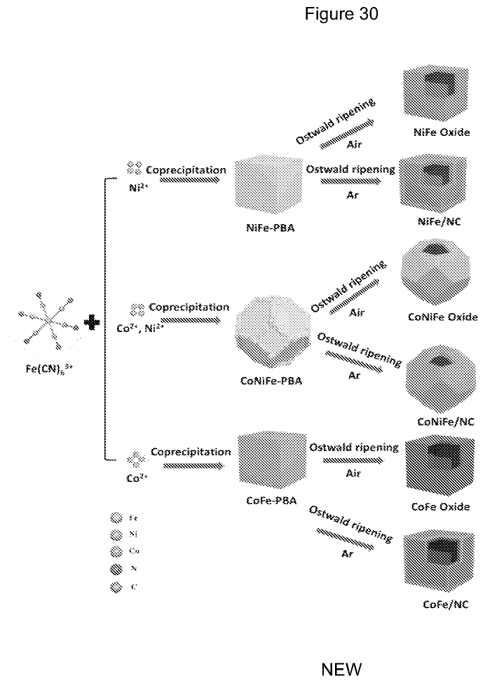

As presented in FIG. 1a, a field-emission scanning electron microscopic (FE-SEM) image shows that hollow Ni—Fe NCs were successfully synthesized via a facile Prussian blue analogues (PBA) method, with an average size of 208 nm (FIG. 1b). The weight loss of the template was investigated via thermogravimetric analysis. As depicted in FIG. 1c, the first stage of weight reduction at nearly 80° C. could be explained by the loss of surface water molecules. The weight loss of the second stage (340° C.) was attributed to the conversion of the PBA structure to the final metal oxides. As illustrated in FIG. 30, with different Co/Ni ratio regulation and the thermal conversion of Co_{y}Ni_{1-y}Fe-PBA at 350° C. under Ar conditions, the CN⁻ groups of the PBA were converted into the N-doping carbon layer (N/C), where Co, Ni and Fe species were transformed to CoNiFe oxides.³² Concurrently, as Co-doping content increased, the color of the CoNiFeO—N/C-x (x refers Co ratio, 0, 0.2, 0.4, 0.6, 0.8 and 1) catalyst inks became dark brown (FIG. 1d). Considering the function of the carbon layer in the electrochemical reaction, the carbon-free catalysts were also discussed, where these of Co_{y}Ni_{1-y}Fe-PBA were ripened at 350° C. by air-condition to form the CoNiFeO-x catalysts.

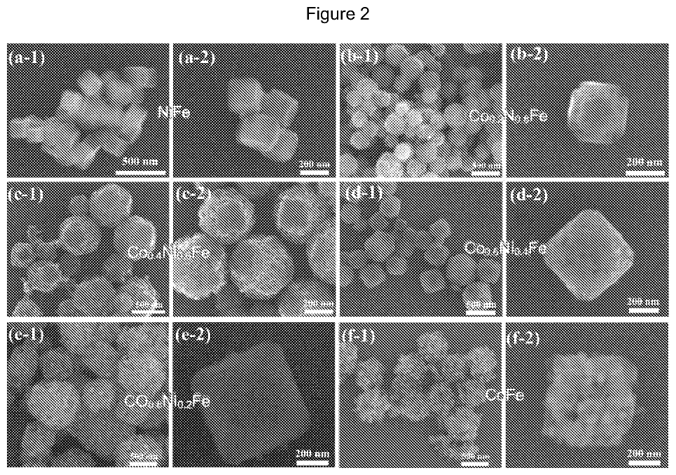

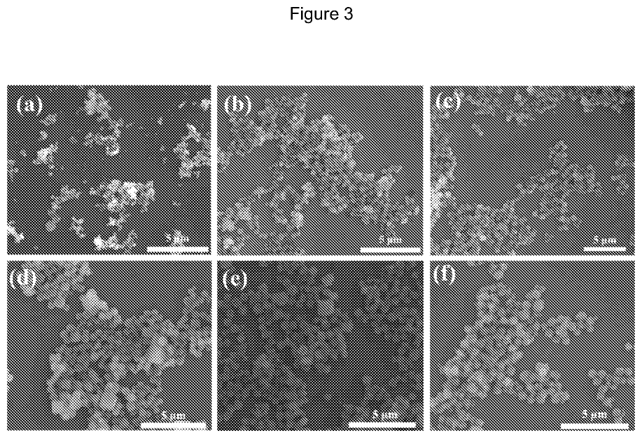

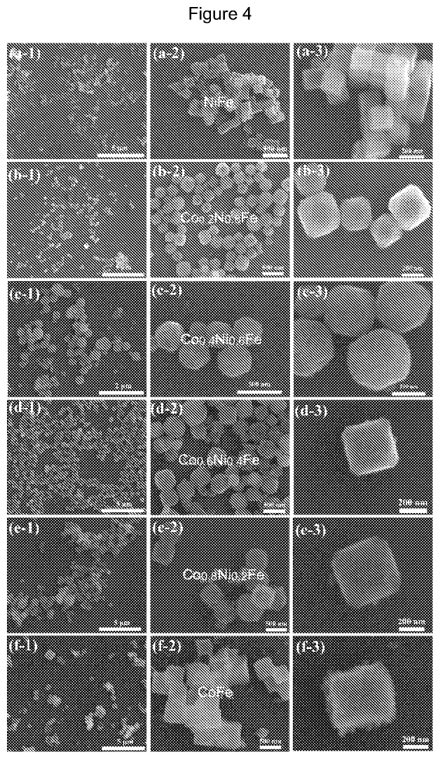

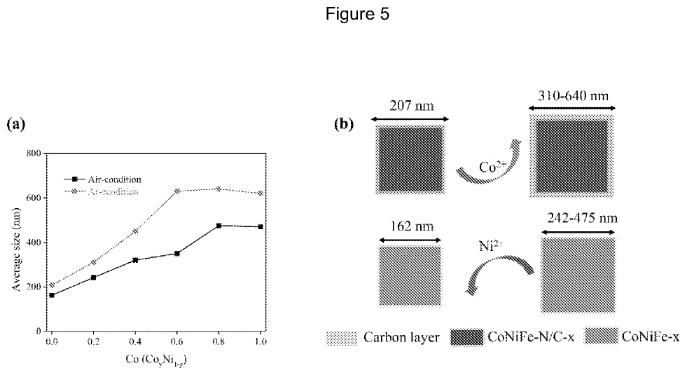

The morphology of the as-prepared CoNiFe catalysts was examined by FE-SEM. As shown in FIG. 2, with increasing Co content, they showed similar morphologies of nanocubes (NCs) when subjected to treatment under Ar conditions; however, the dimensions (FIG. 3) and microstructures of the CoNiFe—N/C-x catalysts obviously changed due to the growth of the carbon layer. Meanwhile, when treated under air conditions, as shown in FIG. 4, they maintained a similar framework and the surfaces of the CoNiFe-x catalysts became much cleaner without the generation of the carbon layer, suggesting that the carbon layer could be removed through the air condition treatment. All the CoNiFe PBA samples showed higher yields when treated under Ar conditions than under air conditions (Table 1), further confirming that a carbon layer was generated on the CoNiFe catalyst surface under the Ar pyrolysis. Interestingly, as the Co content increased, both of the yields exhibited similar distribution trends, which might be ascribed to the metal-support interactions.³³ In addition, the average size of CoNiFe catalysts was calculated and analyzed in FIG. 5a, which displayed a positive relationship with the Co atom content. As shown in FIG. 5b, with the addition of Co, the dimensions of these NCs with carbon layers were increased from 207 to 640 nm. Without the carbon layer, it was enlarged from 162 to 475 nm, indicating that the size fluctuation could be mainly ascribed to the formation of the carbon layer. The elemental composition of the CoNiFe—N/C catalysts was investigated using an energy-dispersive X-ray spectrometer (EDS) (Table 2), which explained that the N-doped carbon was generated from the CoNiFe PBA.

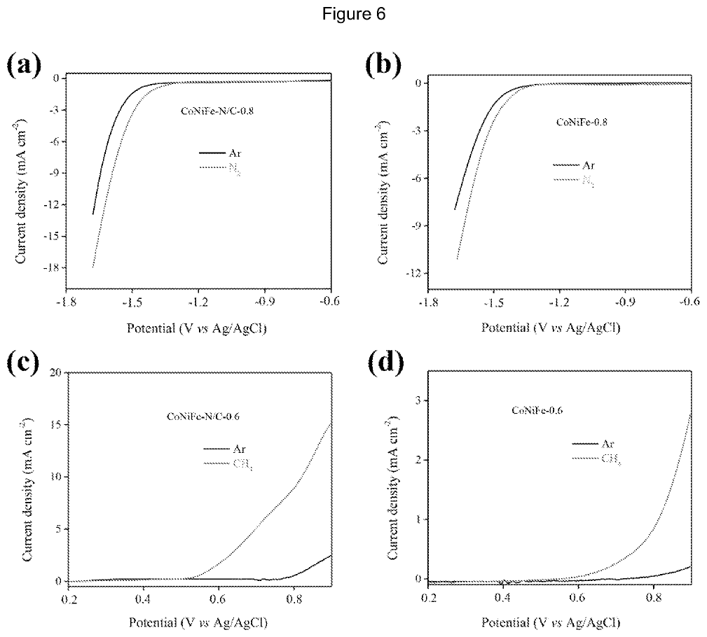

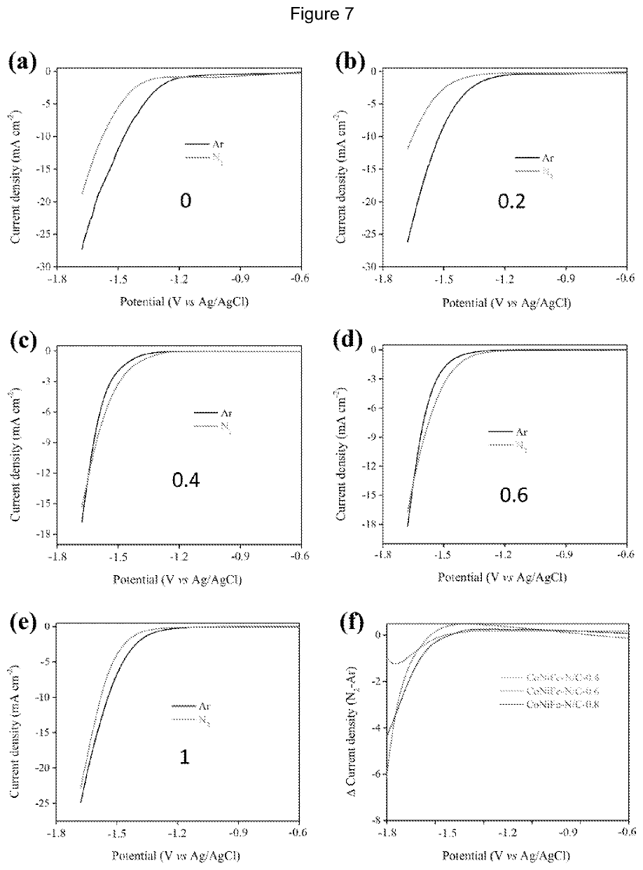

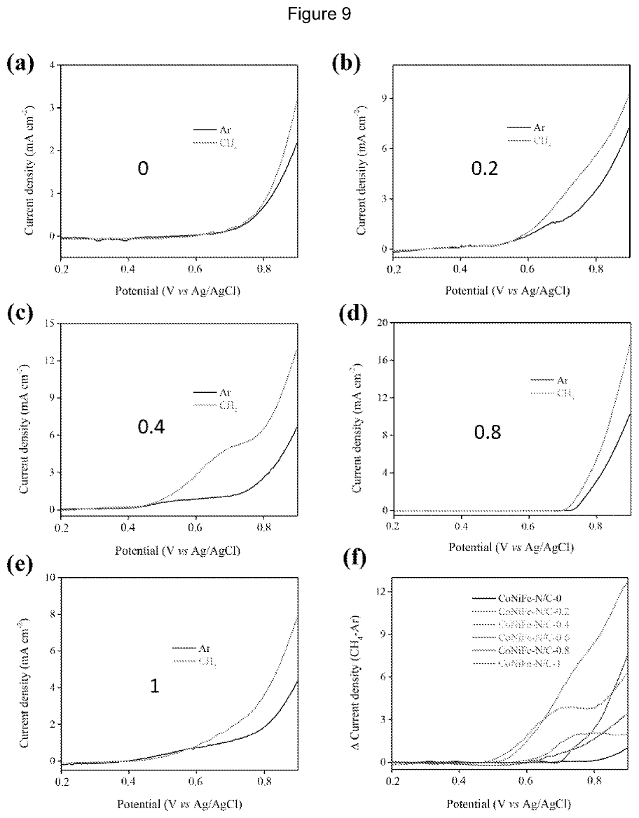

To explore Co/Ni ratio catalysts for the electrochemical redox performance, linear sweep voltammetry (LSV) was employed to evaluate the electrochemical activity toward the NRR and the DMC. As shown in FIGS. 6a & 6b and FIGS. 7 & 8, the cathodic scans of the LSV of a series of Co/Ni composition ratio catalysts were recorded in an Ar- and N₂-saturated 0.1 M Na₂SO₄ solution for comparison, revealing that the composition of CoNiFe and the carbon layer support strongly affected the NRR activity. FIGS. 7f & 8f present the current density differences of the LSVs measured in the N₂-saturated electrolyte and the Ar-saturated electrolyte, revealing that the Co_{0.8}Ni_{0.2}Fe—N/C catalyst exhibited the highest catalytic activity for the NRR. Meanwhile, for the performance of the CH₄ oxidation operating in an Ar- and CH₄-saturated 0.5 M Na₂CO₃ electrolyte, in FIGS. 6c & 6d, both CoNiFe—N/C-0.6 and CoNiFe-0.6 exhibited high CH₄ electrochemical oxidation behavior. As displayed in FIGS. 9 & 10, the LSV curves also demonstrated that the anodic current densities of the CoNiFe—N/C catalysts exhibited a significant improvement over the CoNiFe catalysts. Compared with the carbon-layer-free samples, the calibrated curves further indicated that the onset CH₄ oxidation potentials at the CoNiFe—N/C were lower, with the lowest being 0.49 V vs Ag/AgCl at CoNiFe-0.4. Although the onset potential of CoNiFe—N/C was 0.54 V, it exhibited a remarkable anodic current density for CH₄ oxidation. Overall, the CoNiFe—N/C-0.6 catalyst was employed as the optimized electrode for the CH₄ oxidation reaction. Based on the above data and analysis, the carbon layer support with CoNiFe oxides would be beneficial for improving electrochemical performance, especially for the NRR and DMC.

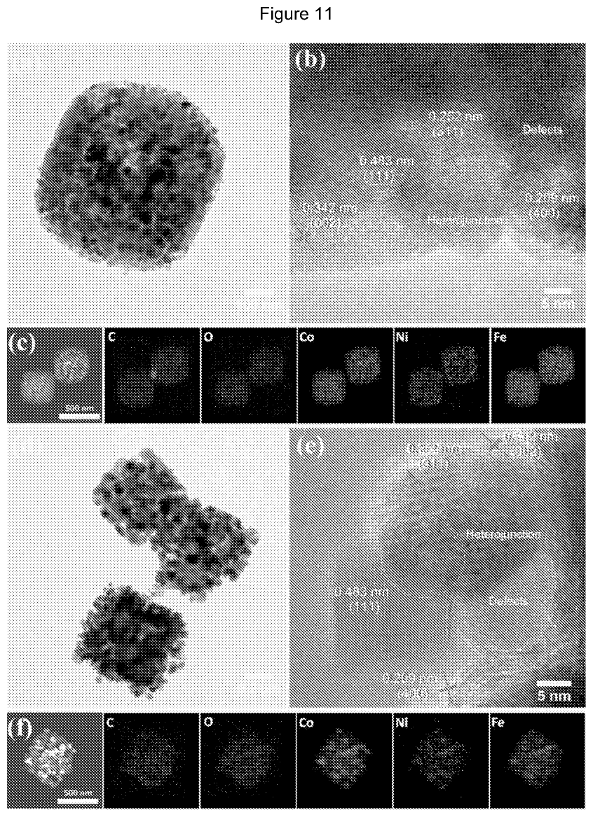

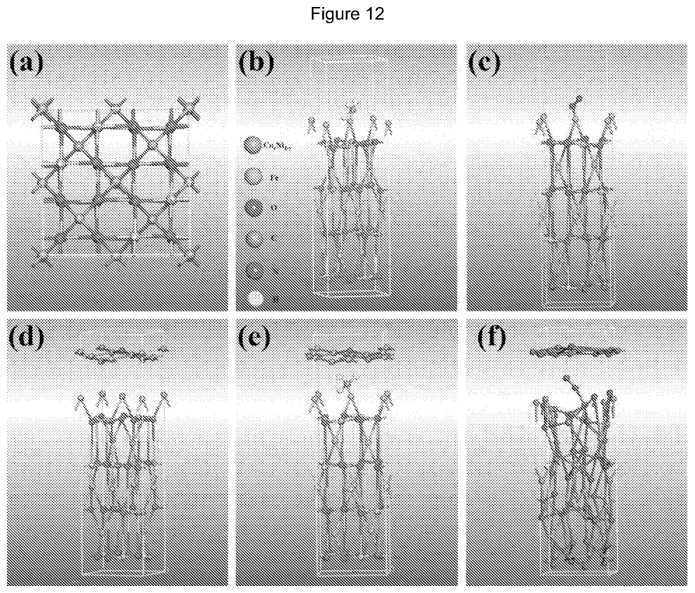

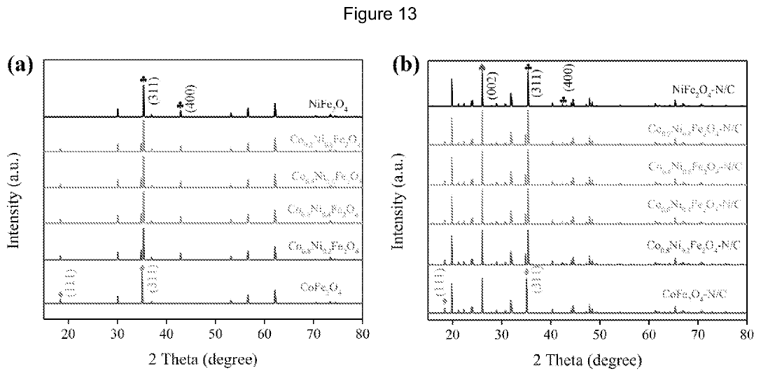

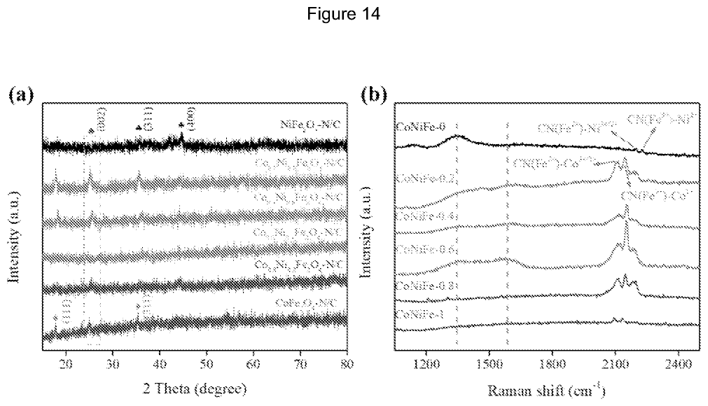

To further explore the crystal structure of these catalysts, transmission electron microscopy (TEM), crystal model construction and X-ray diffraction patterns (XRD) were employed. In the TEM images (FIG. 11), the optimized CoNiFe—N/C-0.8 and CoNiFe—N/C-0.6 catalysts presented cubical structures comprised of nanoparticles, and the carbon film could also be easily seen. High-resolution TEM (HRTEM) images (FIGS. 11b & 11e) depicted the lattice fringes of 0.209 nm, 0.252 nm and 0.482 nm, which could be ascribed to the facet (002) of NiFe₂O₄, (311) of Co_{y}Ni_{1-y}Fe₂O₄, and (111) of CoFe₂O₄, respectively. Further, the lattice constant of amorphous carbon was found to be 0.342 nm on the edge of the cube, corresponding to the (002) facet, indicating that the crystal structure of the synthesized catalysts was Co_{y}Ni_{1-y}Fe₂O₄—N/C. The lattice fringes of Co_{y}Ni_{1-y}Fe₂O₄ and CoFe₂O₄ were interlaced, indicating that heterojunctions were created. Further, TEM-mapping images demonstrated the uniform metal mixing of Co, Ni, Fe composites (FIGS. 11c & 11f). These results confirmed that Co_{y}Ni_{1-y}Fe₂O₄—N/C catalysts were successfully synthesized in our study. In addition, certain lattice fringes were broken, which suggested that some defects were generated. Following these data, the Co_{y}Ni_{1-y}Fe₂O₄, Co_{y}Ni_{1-y}Fe₂O₄—N/C and the corresponding adsorption models were built as illustrated in FIG. 12. In these models, the molecular connecting groups were considered as the main catalytic active sites. Further, the corresponding simulated XRD patterns were calculated and displayed in FIGS. 13a & 13b. As seen in FIG. 14a, the XRD patterns of the as-prepared CoNiFe—N/C-x samples had characteristic peaks located at 18.28°, 26.15°, 35.69° and 43.36°, which belonged to the facet (111) of CoFe₂O₄ (PDF #22-1086), (002) of N-doping carbon (PDF #50-1249), (311) and (400) of NiFe₂O₄ (PDF #10-0325), respectively, which agreed with the earlier HRTEM results. The Co_{y}Ni_{1-y}Fe₂O₄—N/C catalysts were further investigated by Raman spectroscopy (FIG. 14b). Two peaks located at 2198 cm⁻¹ and 2225 cm⁻¹ for CoNiFe-x (except x≠1) were assigned to the vibrations of CN(Fe²⁺)—Ni^{3+/2+} and CN(Fe³⁺)—Ni²⁺, respectively; CoNiFe samples (except x≠0) showed two similar signal peaks at 2111 cm⁻¹ and 2143 cm⁻¹, which were attributed to CN(Fe²⁺)—Co^{3+/2+} and CN(Fe³⁺)—Co²⁺, respectively. Moreover, it exhibited two weak signals at 1346 cm⁻¹ and 1585 cm⁻¹, corresponding to the D-band and G-band of the carbon material, respectively.

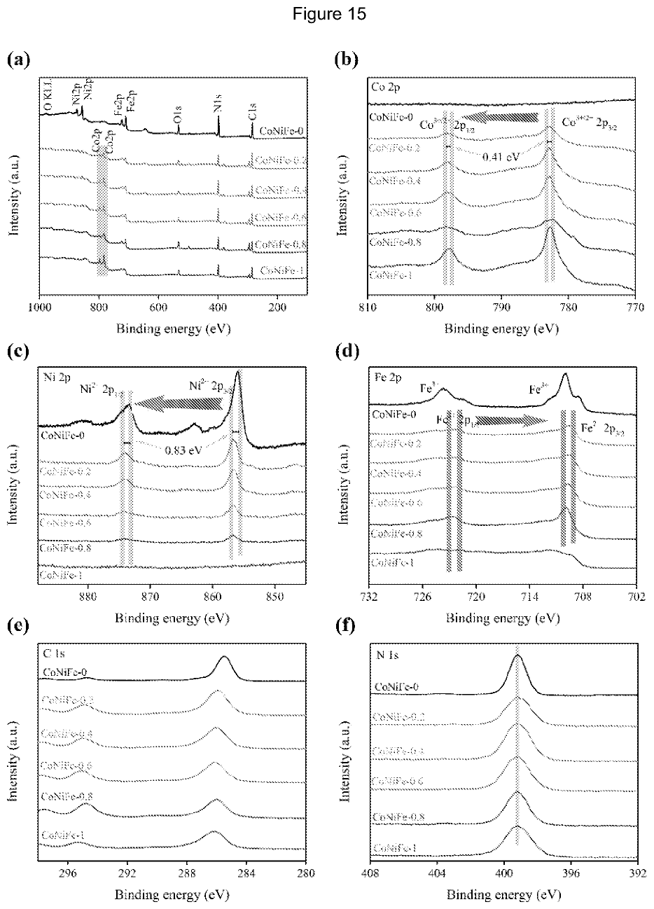

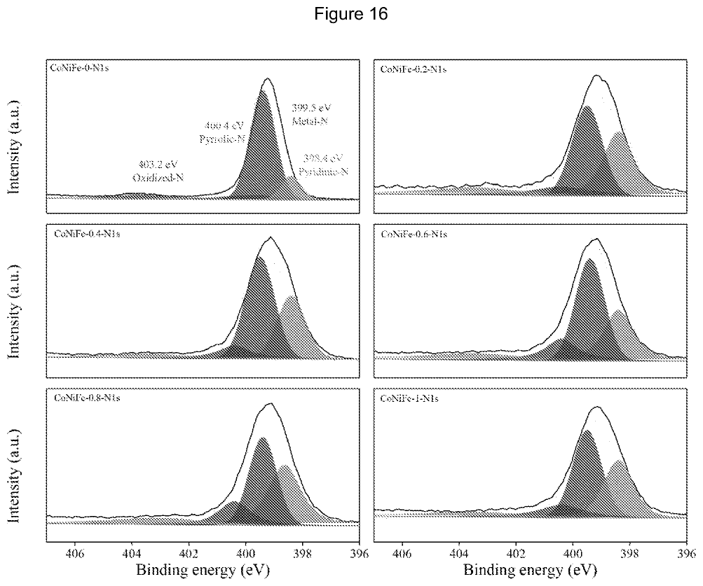

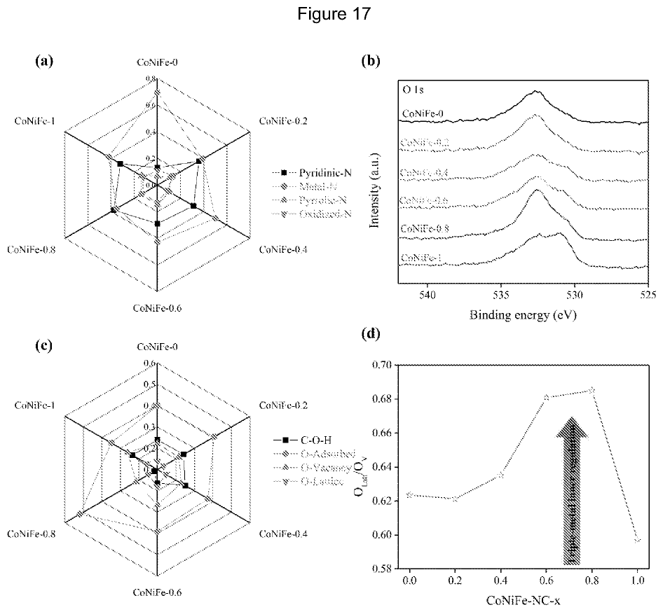

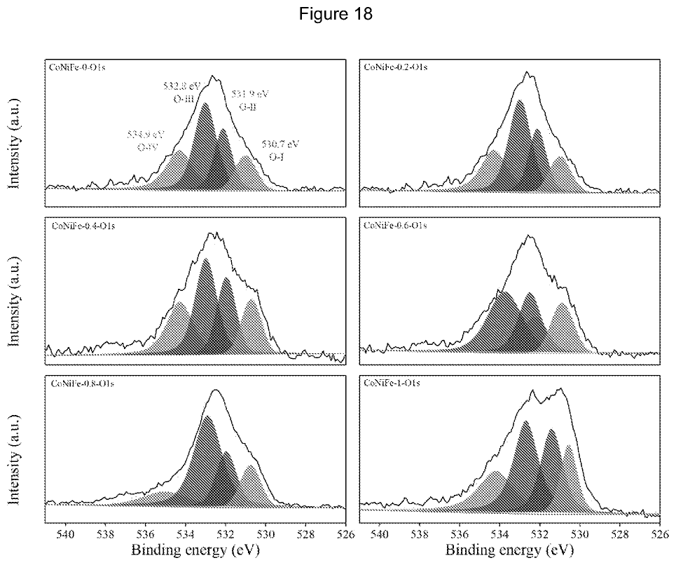

The surface chemical states and bonding environments of the Co_{y}Ni_{1-y}Fe₂O₄—N/C samples were investigated using the X-ray photoelectron spectroscopy (XPS) technique. In FIG. 15a, the full XPS survey of these catalysts determined the presence of Co, Ni, Fe, C, N, and O elements. The intensity of the Ni signal decreased with the increase of the Co ratio, which was consistent with the EDX analysis. The high-resolution XPS spectra of Co 2p, Ni 2p, Fe 2p, C 1s and N 1s are shown in FIGS. 15b-f. The binding energy of three metals had obvious shifts with the change of the Co/Ni ratio, the peaks of Co and Ni shifted to higher binding energies, while Fe signals moved to lower binding energies, indicating strong trimetallic interaction effects. For the carbon layer, the C 1s peaks of the CoNiFe-x samples were affected by the content of Co atoms. In the corresponding N 1s analysis (FIG. 15f), the N 1s signal had a weak fluctuation. As shown in FIG. 16, four fitted peaks located at 398.4, 399.5 400.4 and 403.2 eV from the Co_{y}Ni_{1-y}Fe₂O₄—N/C samples were ascribed to pyridinic-N, metal-N, Pyrrolic-N and oxidized-N, respectively, which confirmed the formation of the N-doped carbon layer. After quantitatively calculating each content of the N-groups (FIG. 17a), it was found that the higher metal-N percentage might be beneficial for the DMC and NRR, and that more pyridinic-N species facilitated the performance of the DMC. In FIG. 17b, the O 1s plots displayed significant changes in intensity and curve shapes (FIG. 18). The signal of O 1s could be divided into four peaks positioned at 530.7, 531.9, 532.8 and 534.9 eV, corresponding to lattice oxygen with metals (O_{Latt}, O-I), oxygen vacancy (O_{V}, O-II), surface-adsorbed oxygen (O_{ad}, O-III) and C—O—H (O-IV), respectively. Furthermore, the percentage of each oxygen species was calculated in FIG. 17c, as the surface-absorbed oxygen group might play an important role in electrochemical performance. Vacancy engineering indicated that the oxygen vacancy was a promising strategy for enhancing the activity of the oxygen evolution reaction (OER). Impressively, in this work, higher oxygen vacancies did not appear to promote the performance of the DMC. As shown in FIG. 17d, the ratio of the O_{Latt}/O_{V} curve displayed a volcano-like trend, which revealed that the highest value of O_{Latt}/O_{V} was favorable for improving the NRR and the DCM. This might be ascribed to the triple-metal inner regulation effect for hindering the OER performance.

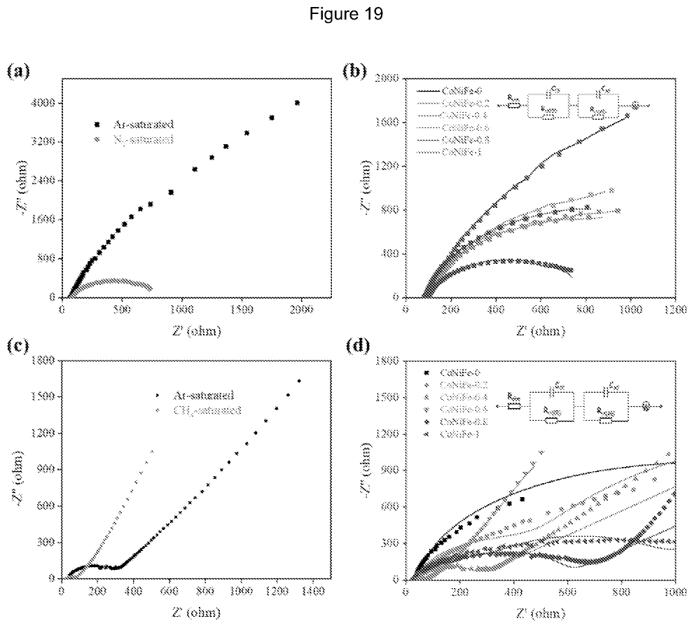

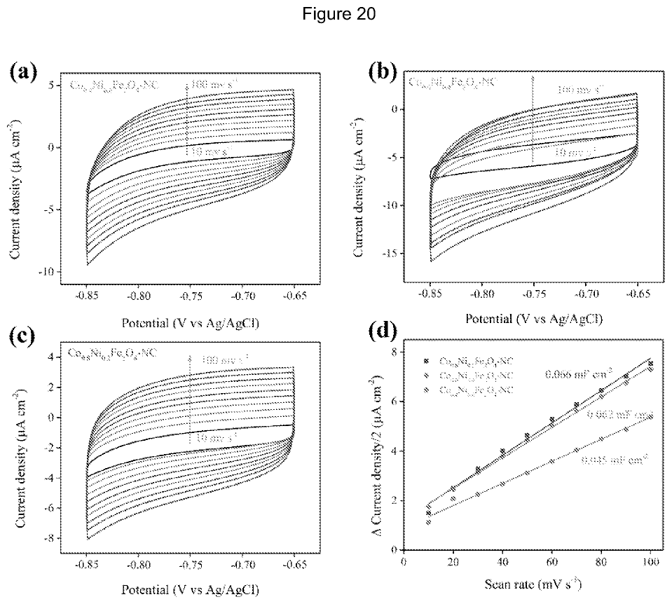

To evaluate the rate-determining step of the NRR and the DCM over the surface of CoNiFe—N/C-x catalysts, electrochemical impedance spectroscopy (EIS) was performed to analyze the charge transfer of the redox conditions. As shown in FIGS. 19a-19c, the CoNiFe—N/C-0.8 catalyst exhibited the smallest semicircle, which suggested that it possessed excellent charge transfer at the electrode surface in the electrochemical NRR. An equivalent circuit model (FIG. 19c inset) was employed to fit the EIS curves with the corresponding values listed in Table 3. during the various ratio of Co/Ni, the Co_{0.8}Ni_{0.2}Fe₂O₄—N/C catalyst displayed the lowest charge transfer resistance (R_{ct}), R_{ct(CE)} and R_{ct(AE)}, demonstrating that the optimized Co_{0.8}Ni_{0.2}Fe₂O₄—N/C catalyst had an excellent electron transfer capacity in the electrochemical NRR. Meanwhile, the EIS measurements made in a 0.5 M Na₂CO₃ electrolyte (FIGS. 19d-19f) revealed that the Co_{0.6}Ni_{0.4}Fe₂O₄—N/C had a lower Rot compared to the other Co/Ni ratio catalysts. The smallest Rot values (Table 4) with the CoNiFe—N/C-0.6 catalyst were consistent with the LSV measurements, where the highest anodic current density was achieved. The electrochemically active surface areas (ECSAs) of the Co_{y}Ni_{1-y}Fe₂O₄—N/C catalysts were estimated based on their double-layer capacitances. FIGS. 20 & 21 showed the orders of Co_{0.8}Ni_{0.2}Fe₂O₄—N/C>Co_{0.6}Ni_{0.4}Fe₂O₄—N/C>Co_{0.4}Ni_{0.6}Fe₂O₄—N/C and Co_{0.6}Ni_{0.4}Fe₂O₄—N/C>Co_{0.4}Ni_{0.6}Fe₂O₄—N/C>Co_{0.8}Ni_{0.2}Fe₂O₄—N/C in the N₂-saturated Na₂SO₄ and CH₄-saturated Na₂CO₃ solution, respectively. The Co_{0.8}Ni_{0.2}Fe₂O₄—N/C for the NRR and the Co_{0.6}Ni_{0.4}Fe₂O₄—N/C for the DMC exhibited the highest ECSA, suggesting that they possessed the most abundant electrochemically active sites for the NRR and the DMC, respectively. These electrochemical results indicated that the optimized catalysts for N₂ reduction and CH₄ oxidation were Co_{0.8}Ni_{0.2}Fe₂O₄—N/C and Co_{0.6}Ni_{0.4}Fe₂O₄—N/C, respectively.

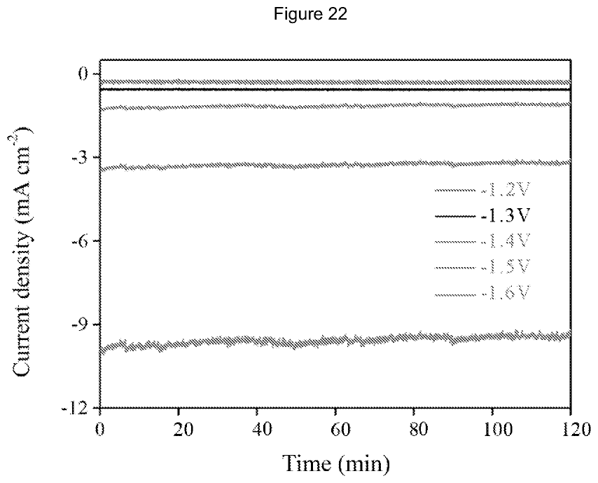

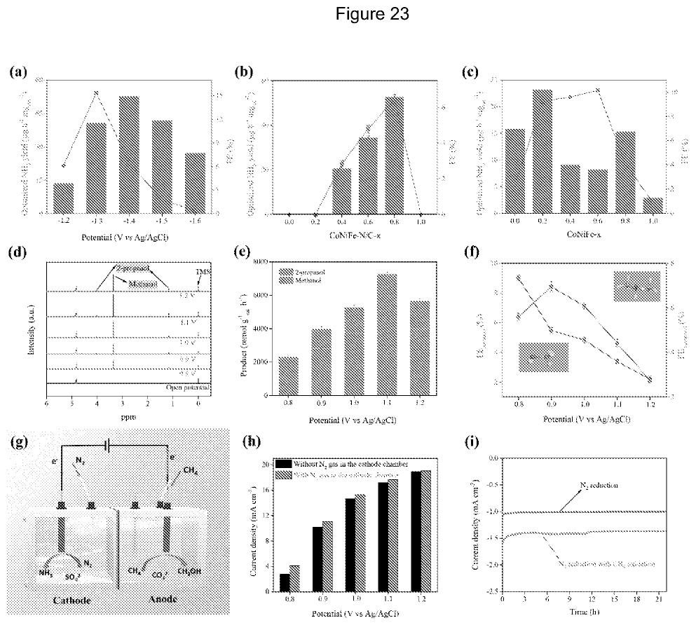

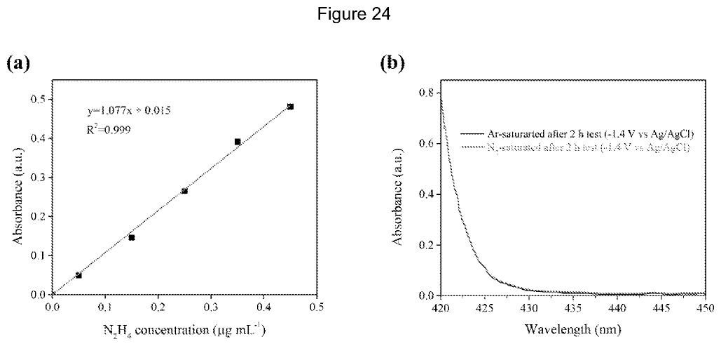

To evaluate the electrochemical activity of the as-prepared CoNiFe-based catalysts for N₂ reduction and CH₄ oxidation, they were performed in a homemade double chamber with a graphite rod as the counter electrode at room temperature. FIG. 22 presents the chronoamperometric curves of CoNiFe—NC-0.8 for the NRR, showing that the current density increased with the increasing cathodic potential from −1.2 to −1.6 V, which is consistent with the LSV results displayed in FIG. 3a. As shown in FIG. 23a, Co_{0.8}Ni_{0.2}Fe₂O₄—N/C exhibited the highest NH₃ yield rate of 52.35 μg h⁻¹ mg_{cat.}⁻¹ at −1.4 V vs Ag/AgCl and the maximum FE of 15.35% at −1.3 V vs Ag/AgCl. Compared with the CoNiFe—N/C-x samples at the potential of −1.4 V vs Ag/AgCl (FIG. 23b), only the catalysts with x=0.4, 0.6 and 0.8 exhibited catalytic activity for the NRR, where the Co_{0.8}Ni_{0.2}Fe₂O₄—N/C showed the best NRR performance. To investigate the effect of the carbon layer, the CoNiFe-x catalysts were also tested at the same potential of −1.4 V vs Ag/AgCl. As shown in FIG. 23c, the highest NH₃ yield rate of 23.22 μg h⁻¹ mg_{cat.}⁻¹ was achieved at CoNiFe-0.2, while the highest FE of 10.14% was obtained at CoNiFe-0.6. The aforementioned results suggested that the interactions between Co_{y}Ni_{1-y}Fe₂O₄ (y=0.4, 0.6 and 0.8) and the carbon layer were beneficial for improving the NRR activity. The possible formation of the by-product (N₂H₄) was further investigated using the Watt and Chrisp method. FIG. 24a presents a plot with a series of standard N₂H₄, showing that the absorbance of N₂H₄ was linearly increased with the increase of its concentration. However, as shown in FIG. 24b, the UV-vis spectra of the solution after two-hour electrolysis under the Ar- and N₂-saturated conditions were almost identical; there was no absorbance change, confirming that no N₂H₄ was generated during the NRR at the Co_{0.8}Ni_{0.2}Fe₂O₄—N/C and that N₂ was reduced to NH₃. On the other hand, the by-product H₂ was detected by gas chromtograph (GC), showing that the hydrogen evolution reaction occurred at the cathode during the NRR. Some promising Co/Ni/Fe-based catalysts recently reported for the NRR, such as CoO QDs/rGO,⁴³ CoFe₂O₄/rGO,⁴⁴ single atoms Co—N/C,⁴⁵ NiCo₂O₄—N/C,⁴⁶ single-atom Fe/N-O/C,⁴⁷ and Fe—N/C-carbon nanotubes,⁴⁸ etc., were compared in Table 5, showing that the Co_{0.8}Ni_{0.2}Fe₂O₄—N/C developed in the present study exhibited superb N₂ reduction activity.

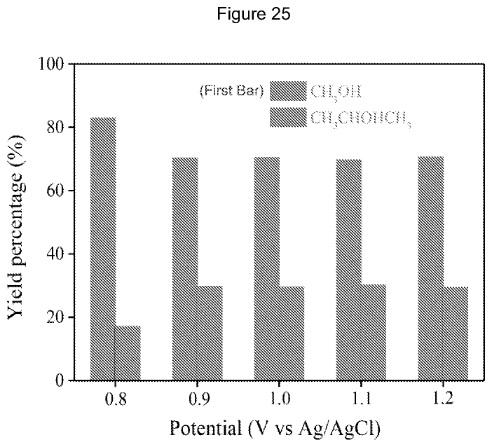

For CH₄ oxidation in the anode chamber, Co_{0.6}Ni_{0.4}Fe₂O₄—N/C catalyst was tested in the anode chamber. The DMC products were collected after two hours of the electrolysis of the CH₄-saturated Na₂CO₃ solution at the potential of 0.8 V vs Ag/AgCl and analyzed by ¹H nuclear magnetic resonance spectroscopy (¹H NMR), methanol and 2-propanol were detected with yields of 722.6 mmol g_{cat.}⁻¹ h⁻¹ and 306.4 mmol g_{cat.}⁻¹ h⁻¹, respectively, as listed in Table 6. To fully utilize both the anodic and cathodic reactions, an integrated electrochemical system was assembled and tested for the simultaneous NRR at Co_{0.8}Ni_{0.2}Fe₂O₄—N/C in the cathode chamber and the DMC at Co_{0.6}Ni_{0.4}Fe₂O₄—N/C in the anode chamber as illustrated in FIG. 23g. As displayed in FIG. 23d, the ¹H-NMR spectra of the products collected after two-hour electrolysis at the different potentials exhibited a strong peak, which was attributed to methanol. The intensity of this peak was increased with the increase of the potential from 0.8 to 1.1 V; however, its intensity was decreased when the potential was further increased to 1.2 V. A by-product 2-propanol was also observed in FIG. 23d. To further confirm the results, a control experiment was carried out at the open-circuit potential under the same conditions for 2 h; no methanol and 2-propanol were detected in the resultant ¹H-NMR spectrum. The rates of the methanol and 2-propanol formation were determined after the two-hour electrolysis at different applied electrode potentials. As shown in FIG. 23e and FIG. 25, methanol was the main product with the highest yield rate of 5070.7 mmol g_{cat.}⁻¹ h⁻¹ obtained at 1.1 V vs Ag/AgCl and a maximum selectivity of 82.8% at 0.8 V vs Ag/AgCl with the yield of 1925.47 mmol g_{cat.}⁻¹ h⁻¹, respectively. The FEs of the production of methanol and 2-propanol are presented in FIG. 23f; the highest FE (9.02%) for methanol production was achieved at 0.8 V, while the highest FE (6.94%) for 2-propanol formation was obtained at 0.9 V. As shown in Table 6, the yield and FE of methanol were increased by 2.7 and 2.4 times compared to those measured without NRR, respectively, while there was a weak improvement for 2-propanol. FIG. 23h showed that the anodic current density measured from the LSVs conveyed some improvement. The impact of the integrated electrochemical system on the NRR was also examined (Table 7), showing that the NH₃ yield rate was enhanced by 1.6 times. The stability of the integrated two electrochemical processes was further tested (FIG. 23i), showing high stability during the 12-hour electrolysis. The aforementioned results showed that the integrated electrochemical system was efficient for the simultaneous NRR in the cathode chamber and DMC in the anode chamber. In comparison with the published work on the DMC at various anode materials (Table 8), such as TiO₂,¹⁸ Ni-based catalysts,^{15, 23} ZrO₂-based catalysts,^{13, 14, 24} and CuO/CeO₂ catalyst,¹⁹ Co_{0.6}Ni_{0.4}Fe₂O₄—N/C catalyst exhibited the best conversion of CH₄ to CH₃OH.

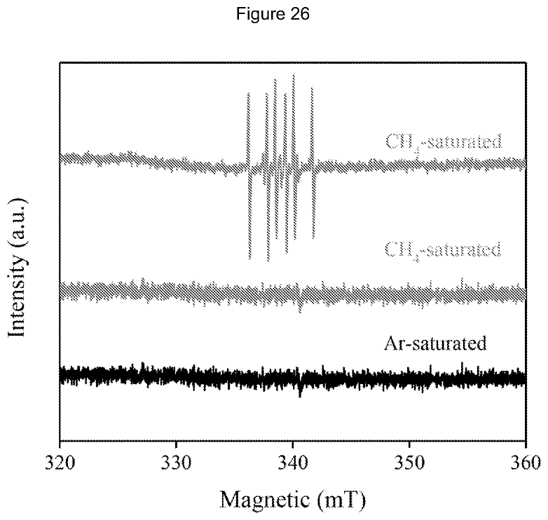

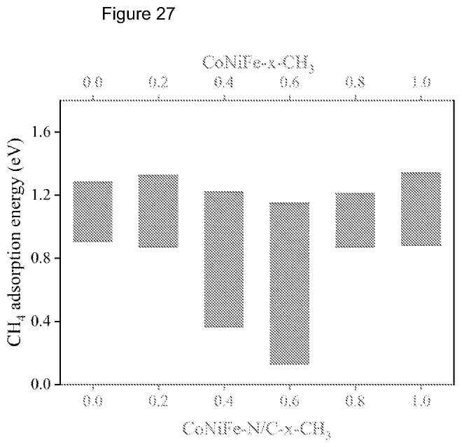

To explore the electronic structures and suitable Co/Ni molar ratios of the as-prepared Co_{y}Ni_{1-y}Fe₂O₄—N/C NCs catalyst, density functional theory (DFT) calculations were performed to reveal the adsorption energies for the DMC and the NRR at Co_{0.6}Ni_{0.4}Fe₂O₄—N/C and Co_{0.8}Ni_{0.2}Fe₂O₄—N/C, respectively. Combining the obtained electron paramagnetic resonance (EPR) spectra (FIG. 26) with the previous work,⁹ the super oxygen radical (·O₂⁻) was determined to be the active species, demonstrating that Co_{0.6}Ni_{0.4}Fe₂O₄—N/C could selectively activate CH₄ to form —CH₃. Further, the adsorption energy of CH₄ over the surface of CoNiFe-x and CoNiFe—N/C-x was calculated by Eq. S11 in the Supporting Information. As shown in FIG. 27, the Co_{0.6}Ni_{0.4}Fe₂O₄—N/C catalyst displayed the lowest CH₄ adsorption energy, which confirmed that it could serve as a viable catalyst for the effective activation of CH₄. As Ma et al.²⁴ and Park et al.¹³ demonstrated in their studies, if the methanol product happened to be over-oxidized to 1-propanol or 2-propanol, the formaldehyde or acetaldehyde intermediates could be easily detected in the ¹H-NMR spectra; however, there were no signals related to the generation of these two by-products. Based on the ¹H-NMR results and the information reported in the literature,²² the simultaneous reaction routes for the DMC and the NRR could be summarized as follows:

Integrated electrochemical system:

Anode:

CH₄+2OH⁻→CH₃OH+H₂O+2e⁻ (1)

3CH₄+6OH⁻→CH₃CHOHCH₃+5H₂O+6e⁻ (2)

4OH⁻→2H₂O+O₂+4e⁻ (3)

Cathode:

N₂+6H₂O+6e⁻→2NH₃+6OH⁻ (4)

2H₂O+2e⁻→H₂+2OH⁻ (5)

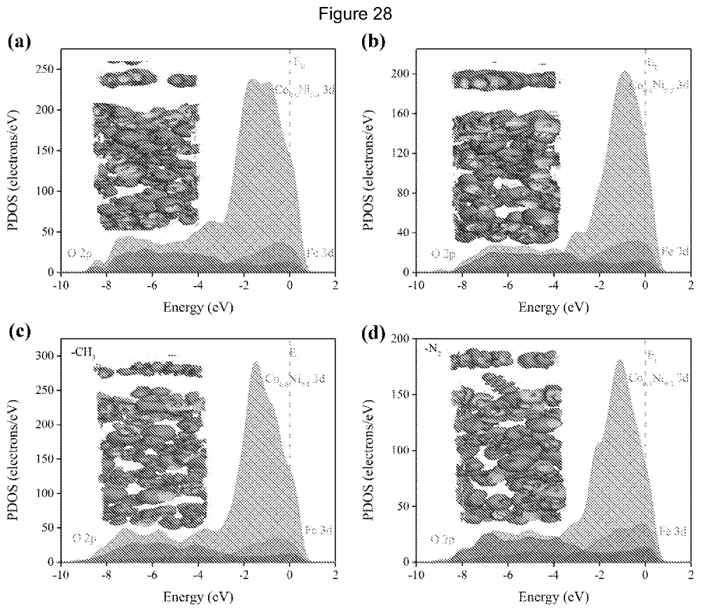

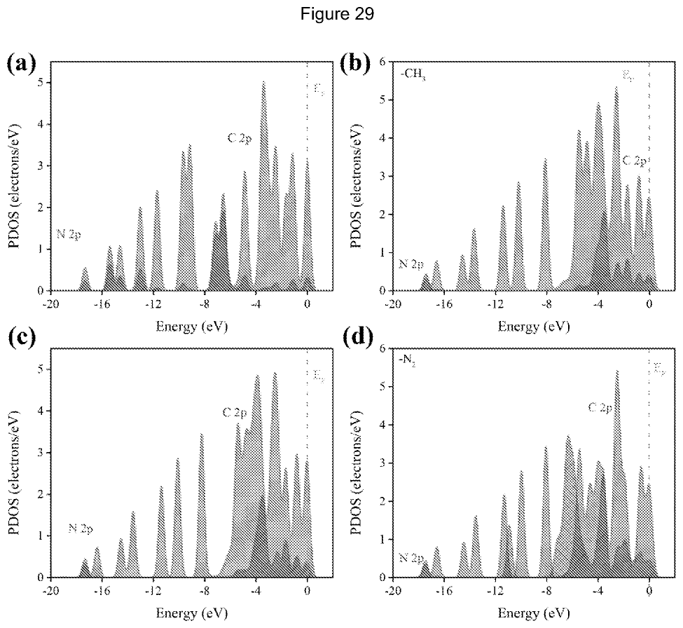

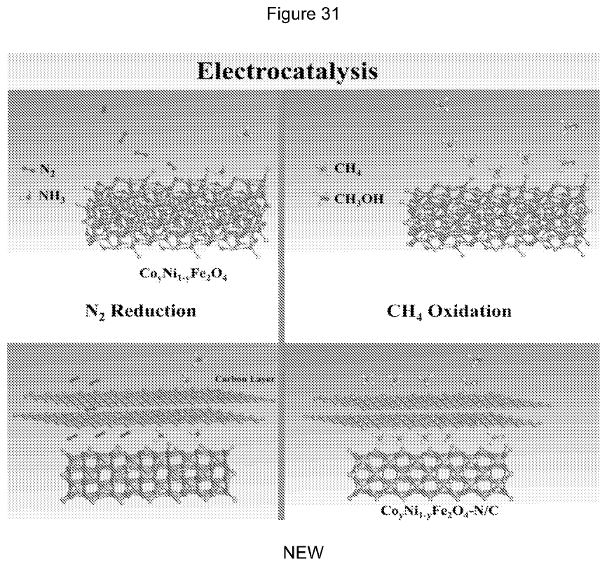

In this integrated system, CH₄ was selectively oxidized to methanol and 2-propanol by the active radical (·O₂⁻) over a Co_{0.6}Ni_{0.4}Fe₂O₄—N/C catalyst in the anode chamber, which was ascribed to the tri-metal-carbon layer interactions. The electrons generated from the anodic oxidation reactions (1)-(3) were transferred to the cathode Co_{0.8}Ni_{0.2}Fe₂O₄—N/C, which facilitated the cathodic reductions (4) & (5). Subsequently, the possible mechanism of the combined electrochemical system could be presented in FIG. 31. The electron transfer pathways during the CH₄ and NRR over the optimized catalysts were also explored in FIG. 28. For the CH₄ oxidation on the surface of Co_{0.6}Ni_{0.4}Fe₂O₄—N/C, the partial density of states (PDOS) exhibited highly concentrated electrons, and the shape of the electron orbital distribution was also significantly altered after adsorbing the CH₄ molecule. The overlapping of Co_{0.8}MNi_{0.4}-3d bands, Fe 3d bands and O 2p bands suggested a strong coupling between the tri-metals and oxygen. Additionally, following the activation of CH₄, electron density difference (EDD) mapping indicated that the generated electrons would quickly transfer to the Co_{0.6}Ni_{0.4} atoms, as shown in the inset of FIG. 28c. Besides, the PDOS of the carbon layer (FIGS. 29a & 29b) revealed that N-doping carbon played a critical role in the electron transfer, as it provided efficient electron transfer channels. Co_{0.6}Ni_{0.4} and Fe were thus considered as the main catalytic centers for the DMC. and In the NRR condition, compared with the bulk catalyst, the intensity of the dominant peak of Co_{0.8}Ni_{0.2} in Co_{0.8}Ni_{0.2}Fe₂O₄—N/C was decreased due to the electron transfer with N₂ (FIG. 28d). Meanwhile, the wave and overlay of the Co_{0.8}Ni_{0.2}-3d bands and 0-2p bands on the catalyst suggested that the N₂ molecules could be easily activated by Co_{0.8}Ni_{0.2} active sites and active oxygen groups, which was agreed with the EDS mapping, where the electrons released from Co_{0.8}Ni_{0.2} were transferred to N₂. In FIGS. 29c & 29d, the PDOS of the carbon layer from the Co_{0.8}Ni_{0.2}Fe₂O₄—N/C catalyst revealed that the intensity of the N-2p bands was improved with the adsorption of N₂, indicating that it accelerated the electron transfer. The DFT results demonstrated that the interactions between the trimetallic CoNiFe and carbon layers greatly improved the performance of the CH₄ oxidation and the N₂ reduction.

Electrochemical Activity Evaluation

A two-chamber cell separated by a pre-treated cation exchange membrane (CEM) was used to investigate the products of each chamber. When a single reduction or oxidation reaction was investigated in one chamber, the other chamber was examined without gas bubbling. For the NRR experiments, a graphite rod was used as the counter electrode. In the cathode chamber with N₂ gas, the generation of ammonia (NH₃) was measured and quantitatively analyzed by the modified indophenol blue method.¹2 As follows, 2 mL of the cathode effluent was taken, then 2 mL of solution A (10.0 g salicylic acid and 10.0 g sodium citrate dissolved in 0.32 M NaOH solution), 1 mL 0.05 M NaClO and 0.2 mL of 0.01 g mL-¹ C₅FeN₆Na₂O was dropped into the testing solution in turn. After 2-hours, the concentration was measured at 655 nm by UV-vis spectrophotometer (Varian Cary 50). A calibration curve was generated using 0.0, 0.2, 0.4, 0.6, 0.8 and 1.0 μg mL-¹ of standard NH₄Cl vs. the corresponding UV-vis absorbance, giving a clear linear relationship (y=0.113 x+0.013, R²=0.999) in triplicate parallel experiments. Each time, the open circuit and Ar-saturated conditions for the NRR experiment were taken as the baseline for the NH₃ yield calculation to avoid any exogenous sources of nitrogen compounds.³ The optimized C_{[NH}_{₃}_{]} generation in the NRR was calculated as follow:

C_{[NH}_{₄}_{⁺}_{]}=C_{[NH}_{₃}_{]}^{N}^{₂}−C_{[NH}_{₃}_{]}^{Ar}−C_{[NH}_{₃}_{]}^{Open} (S1)

where C_{[NH}_{₃}_{]}^{N}^{₂}, C_{[NH}_{₃}_{]}^{Ar}, C_{[NH}_{₃}_{]}^{Open} are obtained under the N₂-saturated, Ar-saturated and open-circuit conditions for the NRR experiments, respectively.

The NH₃ yield was calculated by the following equation:

NH₃ yield=C_{[NH}_{₄}_{⁺}_{]}*V/(m_{cat.}*t) (S2)

where C_{[NH}_{₄}_{⁺}_{]} is the obtained NH₃ concentration; V is the reaction electrolyte solution (20 mL); m_{cat.} is the mass of the catalyst, and t is the time of electrolysis reaction (t=2 h).

Faradaic efficiency was obtained as follows:

FE=3*F*C_{[NH}_{₄}_{⁺}_{]}*V/(18*Q) (S3)

where F is the Faraday constant (96485.3 C mol⁻¹); Q is the quantity of electric charge by the applied potential. Besides, the potential by-product (N₂H₄) was also investigated by our formerly reported method.⁴ There was no change for the initial and 2 h for the NRR in the UV-vis spectrum at 455 nm, suggesting that there is no any N₂H₄ generation in this system.

In the anode chamber, the CH₄ oxidation reaction was investigated. The pure CH₄ gas was continuously purged into 0.5 M Na₂CO₃ electrolyte at a flow rate of 5 mL min⁻¹. All the gas products were detected by gas chromatography. Liquid products of the CH₄ electrochemical oxidation were analyzed by ¹H nuclear magnetic resonance spectroscopy (¹H NMR) measured on a 600 MHz NMR spectrometer (Bruker). Before the measurement, a 0.35 mL sample from the anode chamber was mixed with 0.05 wt % tetramethylsilane (TMS) in 0.35 mL D20. The yield of products, FEs, the corresponding selectivity, and the CH₄ conversion rate were calculated as follows:

Yields (mmol g_{cat.}⁻¹ h⁻¹)=mmol of products/g of catalysts/h of the reaction time (S4)

FE(CH₃OH,%)=0.1929*n(CH₃OH,μmol)*100%/Q (S5)

FE(CH₃CHOHCH₃,%)=0.1929*n(CH₃CHOHCH₃,μmol)*100%/Q (S6)

Selectivity of CH₃OH=100%*n(CH₃OH)/(n(CH₃OH)+n(CH₃CHOHCH₃) (S7)

Selectivity of CH₃CHOHCH₃=100%*n(CH₃CHOHCH₃)/(n(CH₃OH)+n(CH₃CHOHCH₃) (S8)

where Q is the total quantity of the electric charge.

The integrated reaction system was comprised of two working electrodes and one reference electrode. Where the Co_{0.8}Ni_{0.2}Fe₂O₄—N/C and Co_{0.6}Ni_{0.4}Fe₂O₄—N/C catalysts were employed as the working electrodes in the cathode and anode chambers, respectively. N₂ gas and CH₄ gas were simultaneously purged into the corresponding electrolytes. Considering the measurement of the current density, the reference electrode would be employed in the same chamber with the targeted reaction. After two-hour electrolysis, the corresponding anode- and cathode-electrolyte would be collected and further analyzed. A blank experiment was carried out to get rid of possible interferences, including blank GCE and NiCoFe catalysts under the open potential condition.

Characterization of Nanomaterials

The morphologies of CoNiFe—N/C and CoNiFe catalysts were characterized using a field-emission scanning electron microscope (FE-SEM) (FEI Quanta 250) and the high-resolution transmission electron microscopy (HRTEM) (FEI Tecnai F30 electron microscope, using a 200 kV accelerating voltage). An X-ray diffractometer with Cu Kα radiation (D/max-2400, Japan, source light at the wavelength (λ) of 0.1541 nm) was employed to investigate the crystallinity structure of the as-prepared catalysts. X-ray Photoelectron Spectroscopy (XPS) (Scienta Omicron) with a monochromatic Al K_{α} x-ray source was used to analyze their chemical composition and oxidation states. Raman spectra were recorded at 532 nm by utilizing a Raman spectrophotometer (Renishaw Canada Ltd.). Thermogravimetric (TG) analysis was performed with a QMA200M thermal analyzer (METTLER TOLEDO) at a heating rate of 2° C. min⁻¹ under air conditions. The radicals were detected via electron paramagnetic resonance (EPR) spectroscopy, which was conducted with a Bruker ECS106 X-band spectrometer (Bruker A200, Germany). The gas products were transferred using a gas-tight syringe (Hamilton) and examined using a gas chromatograph (GC, Shimadzu, GC-2014, Column: silica gel) that was equipped with a thermal conductive detector (TCD).

Theoretical Calculations

To explore the electronic structures and electron transfer in the NRR and CH₄ oxidation systems, the Co_{y}Ni_{1-y}Fe₂O₄ and Co_{y}Ni_{1-y}Fe₂O₄—N/C with one layer of carbon structure models were built based on the NiFe₂O₄ template. The optimization of the constructed structures was enabled by the CASTEP module with the Perdew-Burke-Ernzerhof (PBE) functional of the generalized gradient approximation (GGA). Additionally, the position of the Co doping was thought to be the replacement of Ni atoms with Co atoms. A 2×2×1 3D triclinic NiFe₂O₄ cell (a=8.480 Å, b=8.480 Å, c=8.480 Å, α=β=γ=90°) was used for the doping and the addition of carbon layer cells. A k-point set of 2×1×1 and an energy cut-off of 320 eV were performed to optimize the geometry of the constructed models with medium k-point set. The convergence criterion was 1.0×10⁻⁵ eV for energy and 0.05 eV Â⁻¹ for force. The adsorption energy (E) was calculated as follow:

ΔE_{Co}_{_{y}}_{Ni}_{_{1-y}}(CH3)=E_{Co}_{_{y}}_{Nt}_{_{1-y}}_{-Carbon layer}^{Total}(CH3)−E_{Co}_{_{y}}_{Nt}_{_{1-y}}^{Total}(CH3)−E_{Carbon layer}−E_{CH}_{₄}+E_{H} (S9)

where E_{Co}_{_{y}}_{N}_{_{1-y}}_{-Carbon layer}^{Total}(CH3), E_{Co}_{_{y}}_{Nt}_{_{1-y}}^{Total}(CH3), E_{Carbon layer}, E_{CH}_{₄} and E_{H} are the electronic energies of the Co_{y}Ni_{1-y}Fe₂O₄—N/C, Co_{y}Ni_{1-y}Fe₂O₄, carbon, CH₄ and H unit cell, respectively. For the first principle calculation of the activation of CH₄ to ·CH₃, an energy cut-off of 350 eV was performed. A force tolerance, SCF tolerance, and electronic field were 0.05 eV Â⁻¹, 1.0×10⁻⁵ eV per atom and −5 eV vs. Vacuum, respectively. The experimental optimal potential on the electrode reaction was performed by adding the value of −n eU (n: the number of electrons in the DMC; U: the electric potential).

While the present disclosure has been described with reference to what are presently considered to be the preferred examples, it is to be understood that the application is not limited to the examples described herein. To the contrary, the present disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

### REFERENCES

1. Z. Wang, Y. Li, H. Yu, Y. Xu, H. Xue, X. Li, H. Wang and L. Wang, ChemSusChem, 2018, 11, 3480-3485.
2. L. Xia, X. Wu, Y. Wang, Z. Niu, Q. Liu, T. Li, X. Shi, A. M. Asiri and X. Sun, Small Methods, 2018, 14, 1800251.
3. S. Z. Andersen, V. Colic, S. Yang, J. A. Schwalbe, A. C. Nielander, J. M. McEnaney, K. Enemark-Rasmussen, J. G. Baker, A. R. Singh, B. A. Rohr, M. J. Statt, S. J. Blair, S. Mezzavilla, J. Kibsgaard, P. C. K. Vesborg, M. Cargnello, S. F. Bent, T. F. Jaramillo, I. E. L. Stephens, J. K. Norskov and I. Chorkendorff, Nature, 2019, 570, 504-508.
4. L. Zeng, X. Li, S. Chen, J. Wen, W. Huang and A. Chen, J. Mater. Chem. A, 2020, 8, 7339-7349.
5. X. Han, C. S. Gerke, S. Banerjee, M. Zubair, J. Jiang, N. M. Bedford, E. M. Miller and V. S. Thoi, ACS Energy Lett., 2020, 5, 3237-3243.
6. K. Chu, Y.-p. Liu, Y.-b. Li, H. Zhang and Y. Tian, J. Mater. Chem. A, 2019, 7, 4389-4394.
7. M. I. Ahmed, S. Chen, W. Ren, X. Chen and C. Zhao, Chem. Commun., 2019, 55, 12184-12187.
8. J. Hou, M. Yang and J. Zhang, Nanoscale, 2020, 12, 6900-6920.
9. S. Luo, X. Li, B. Zhang, Z. Luo and M. Luo, ACS Appl. Mater. Interfaces, 2019, 11, 26891-26897.
10. B. Yang, W. Ding, H. Zhang and S. Zhang, Energy Environ. Sci., 2021, 14, 672-687.
11. K. Chu, Y.-p. Liu, Y.-b. Li, Y.-A. Guo and Y. Tian, ACS Appl. Mater. Interfaces, 2020, 12, 7081-7090.
12. K. Lu, F. Xia, B. Li, Y. Liu, I. B. Abdul Razak, S. Gao, J. Kaelin, D. E. Brown and Y. Cheng, ACS Nano, 2021.
13. K. Zhao, X. Quan, Y. Su, X. Qin, S. Chen and H. Yu, Environ. Sci. Technol., 2021.
14. F. Lai, J. Feng, X. Ye, W. Zong, G. He, C. Yang, W. Wang, Y.-E. Miao, B. Pan, W. Yan, T. Liu and I. P. Parkin, J. Mater. Chem. A, 2020, 8, 1652-1659.
15. C. Ma, X. Yan, H. He, B. Liu and S. Yan, Sustain. Energy Fuels, 2021, 5, 2415-2418.
16. J. H. Moon, M. Y. Lee, B. C. Park, Y. S. Jeon, S. Kim, T. Kim, M. J. Ko, K. H. Cho, K. T. Nam and Y. K. Kim, Small, 2021, e2103575.
17. C. Li, Y. Fu, Z. Wu, J. Xia and X. Wang, Nanoscale, 2019, 11, 12997-13006.
18. Y. Li, J. Li, J. Huang, J. Chen, Y. Kong, B. Yang, Z. Li, L. Lei, G. Chai, Z. Wen, L. Dai and Y. Hou, Angew. Chem. Int. Ed., 2021, 60, 9078-9085.
19. W. Ye, Y. Yang, M. Arif, S. Yang, X. Fang, M. A. Mushtaq, X. Chen and D. Yan, ACS Sustain. Chem. Eng., 2020, 8, 15946-15952.
20. Y. Wang, X. Cui, J. Zhao, G. Jia, L. Gu, Q. Zhang, L. Meng, Z. Shi, L. Zheng, C. Wang, Z. Zhang and W. Zheng, ACS Catal., 2018, 9, 336-344.
21. W. Li, D. He, G. Hu, X. Li, G. Banerjee, J. Li, S. H. Lee, Q. Dong, T. Gao, G. W. Brudvig, M. M. Waegele, D. E. Jiang and D. Wang, ACS Cent Sci, 2018, 4, 631-637.
22. Y. Song, Y. Zhao, G. Nan, W. Chen, Z. Guo, S. Li, Z. Tang, W. Wei and Y. Sun, Appl. Catal. B-Environ., 2020, 270, 118888.
23. Z. Guo, W. Chen, Y. Song, X. Dong, G. Li, W. Wei and Y. Sun, Chinese J. Catal., 2020, 41, 1067-1072.
24. Y. Liu, X. Zhu, Q. Zhang, T. Tang, Y. Zhang, L. Gu, Y. Li, J. Bao, Z. Dai and J.-S. Hu, J. Mater. Chem. A, 2020, 8, 8920-8926.
25. M. Ma, C. Oh, J. Kim, J. H. Moon and J. H. Park, Appl. Catal. B-Environ., 2019, 259, 118095.
26. M. Ma, B. J. Jin, P. Li, M. S. Jung, J. I. Kim, Y. Cho, S. Kim, J. H. Moon and J. H. Park, Adv. Sci., 2017, 4, 1700379.
27. C. Oh, J. Kim, Y. J. Hwang, M. Ma and J. H. Park, Appl. Catal. B-Environ., 2021, 283, 119653.
28. J. Wu, J. H. Li and Y. X. Yu, ACS Appl. Mater. Interfaces, 2021, 13, 10026-10036.
29. J. Lee, J. Yang and J. H. Moon, ACS Energy Letters, 2021, 893-899.

TABLE 1
Yields of Co_{y}Ni_{1-y}—Fe PBA catalysts after the high-
temperature treatment under the Air- or Ar-condition.

| | Air condition | | Ar condition | |
|---|---|---|---|---|
| Co-doping | treatment | | treatment | |
| rate | (350° C.)^{a} | Yield^{a} | (350° C. )^{b} | Yield^{b} |
| 0 | NiFe₂O₄ | 55.4% | NiFe₂O₄/N@C | 56.2% |
| 20% | Co_{0.2}Ni_{0.8}Fe₂O₄ | 60.9% | Co_{0.2}Ni_{0.8}Fe₂O₄/N@C | 72.1% |
| 40% | Co_{0.4}Ni_{0.6}Fe₂O₄ | 67.1% | Co_{0.4}Ni_{0.6}Fe₂O₄/N@C | 77.1% |
| 60% | Co_{0.6}Ni_{0.4}Fe₂O₄ | 65.0% | Co_{0.6}Ni_{0.4}Fe₂O₄/N@C | 67.3% |
| 80% | Co_{0.8}Ni_{0.2}Fe₂O₄ | 61.1% | Co_{0.8}Ni_{0.2}Fe₂O₄/N@C | 63.6% |
| 100% | CoFe₂O₄ | 53.9% | CoFe₂O₄/N@C | 62.1% |

TABLE 2
EDX analysis of different Co_{y}Ni_{1-y}Fe₂O₄-N/C catalysts

| | C/At | N/At | O/At | Fe/At | Ni/At | Co/At |
|---|---|---|---|---|---|---|
| Sample | % | % | % | % | % | % |
| CoNiFe-N/C-0 | 51.28 | 37.03 | 10.08 | 0.49 | 1.31 | 0 |
| CoNiFe-N/C-0.2 | 50.89 | 38.41 | 8.89 | 0.62 | 0.98 | 0.21 |
| CoNiFe-N/C-0.4 | 50.77 | 38.57 | 8.33 | 0.68 | 1.06 | 0.59 |
| CoNiFe-N/C-0.6 | 50.54 | 38.31 | 8.36 | 0.87 | 0.73 | 1.19 |
| CoNiFe-N/C-0.8 | 50.31 | 38.07 | 8.60 | 1.06 | 0.34 | 1.62 |
| CoNiFe-N/C-1 | 50.17 | 37.94 | 8.73 | 1.28 | 0 | 1.88 |

TABLE 3
Parameter analysis of the equivalent circuit model corresponding to the Nyquist
plots of the as-prepared Co_{y}Ni_{1-y}Fe₂O₄-C/N under N₂-saturated conditions.

| N₂-saturated | Rₒₕₘ (Ω) | C_{CE} (μF) | R_{ct(CE)} (Ω) | C_{AE} (μF) | R_{ct(AE)} (kΩ) | W(S*Sec⁵) |
|---|---|---|---|---|---|---|
| 0 | 90.4 ± 0.06 | 2.38 ± 0.05 | 4187 ± 0.06 | 8.04 ± 0.01 | 0.18 ± 0.03 | 0.027 ± 0 |
| 0.2 | 92.6 ± 0.04 | 7.17 ± 0.04 | 1850.9 ± 0.04 | 2.87 ± 0.06 | 1.64 ± 0.05 | 0.026 ± 0 |
| 0.4 | 89.8 ± 0.01 | 4.19 ± 0.04 | 2071.7 ± 0.07 | 2.64 ± 0.02 | 1.21 ± 0.01 | 0.0003 ± 0 |
| 0.6 | 88.4 ± 0.07 | 1.53 ± 0.02 | 1276 ± 0.08 | 8.98 ± 0.01 | 0.074 ± 0 | 0.0004 ± 0 |
| 0.8 | 86.3 ± 0.01 | 2.65 ± 0.03 | 541.8 ± 0.02 | 17.5 ± 0.03 | 0.013 ± 0 | 0.0004 ± 0 |
| 1 | 91.5 ± 0.07 | 16.1 ± 0.09 | 6861 ± 5 | 1.76 ± 0.01 | 1.18 ± 0.002 | 0.0003 ± 0 |

Rₒₕₘ = Resistance of solution,
R_{ct(CE)} = Charge transfer resistance,
R_{ct(AE)} = Charge transfer and recombination resistance,
C = Capacitance of double layer,
W = Warburg impedance (mass transfer).

TABLE 4
Parameter analysis of the equivalent circuit model corresponding to the Nyquist
plots of the as-prepared Co_{y}Ni_{1-y}Fe₂O₄-C/N under the CH₄-saturated conditions.

| CH₄-saturated | Rₒₕₘ (Ω) | C_{CE} (μF) | R_{ct(CE)} (Ω) | C_{AE} (μF) | R_{ct(AE)} (kΩ) | W(S*Sec⁵) |
|---|---|---|---|---|---|---|
| 0 | 37.8 ± 0.02 | 1.72 ± 0.02 | 1352 ± 0.04 | 0.02 ± 0 | 2.04 ± 0.04 | 0.0003 ± 0 |
| 0.2 | 34.7 ± 0.03 | 7.08 ± 0.05 | 404.1 ± 0.05 | 3.34 ± 0.03 | 1.96 ± 0.05 | 0.0003 ± 0 |
| 0.4 | 32.1 ± 0.02 | 2.11 ± 0.01 | 40.3 ± 0.03 | 0.002 ± 0 | 1.17 ± 0 | 0.0007 ± 0 |
| 0.6 | 24.0 ± 0.01 | 1.23 ± 0.02 | 38.8 ± 0.03 | 2.34 ± 0.03 | 0.52 ± 0.01 | 0.0024 ± 0 |
| 0.8 | 26.5 ± 0.02 | 1.19 ± 0.03 | 81.8 ± 0.06 | 0.004 ± 0 | 2.39 ± 0.03 | 0.001 ± 0 |
| 1 | 25.2 ± 0.01 | 1.33 ± 0.02 | 264.7 ± 0.04 | 0.008 ± 0 | 2.55 ± 0.01 | 0.0007 ± 0 |

Rₒₕₘ = Resistance of solution,
R_{ct(CE)} = Charge transfer resistance,
R_{ct(AE)} = Charge transfer and recombination resistance,
C = Capacitance of double layer,
W = Warburg impedance (mass transfer).

TABLE 5
Comparison of electrochemical ammonia synthesis
by N₂ fixation at the Co/Ni/Fe-based catalysts.

| | | Faradaic Efficiency | Ammonia Yield | |
|---|---|---|---|---|
| | | (%)/ | (μg h⁻¹ mg⁻¹_{cat}.)/ | |
| Catalysts | Conditions | Bias (V vs. RHE) | Bias (V vs. RHE) | Ref. |
| CoMoO₄ nanoparticles | 0.1M Na₂SO₄ | 10.18/−0.3 | 23.14/−0.3 | ⁵ |
| CoO QDs/rGO | 0.1M Na₂SO₄ | 8.30/−0.6 | 21.50/−0.7 | ⁶ |
| CoFe₂O₄/rGO | 0.1M Na₂SO₄ | 6.20/−0.4 | 5.14/−0.4 | ⁷ |
| Co—N/C | 0.1M KOH | 10.10/−0.1 | 5.10/−0.4 | ⁸ |
| C₃O₄/NC nanocages | 0.05M H₂SO₄ | 8.50/−0.2 | 42.58/−0.2 | ⁹ |
| Co SAs—N/C | 0.05M H₂SO₄ | 10.50/−0.2 | 2.09/−0.2 | ¹⁰ |
| Ni/NiO/C nanotubes | 0.1M KOH | 10.9/−0.7 | 43.15/−0.7 | ¹¹ |
| N—NiO/CC nanosheets | 0.1M LiClO₄ | 7.30/−0.5 | 22.70/−0.4 | ¹² |
| NiO QDs/graphene | 0.1M Na₂SO₄ | 7.80/−0.7 | 18.60/−0.7 | ¹³ |
| NiCO₂O₄—N/C | 0.1M Na₂SO₄ | 5.30/−0.25 | 17.80/−0.25 | ¹⁴ |
| Fe₂O₃ nanorods | 0.1M Na₂SO₄ | 0.94/−0.8 | 15.90/−0.8 | ¹⁵ |
| Fe₂O₃/rGO | 0.1M LiClO₄ | 5.89/−0.5 | 22.13/−0.5 | ¹⁶ |
| Fe/Fe₃O₂/C | 0.2M | 6.25/−0.3 | 15.91*/−0.3 | ¹⁷ |
| Fe SAs/N—O/C | NaHCO₃ | 11.80/−0.4 | 31.90/−0.4 | ¹⁸ |
| FeMo—N/C | 0.1M HCl | 14.2/−0.1 | 38.76/−0.1 | ¹⁹ |
| Fe—N/C-carbon nanotube | 0.1M H₂SO₄ | 9.28/−0.2 | 34.83/−0.2 | ²⁰ |
| FeNi—N/C | 0.1M KOH | 1.75/−0.2 | 23.34/−0.3 | ⁴ |
| Co_{0.8}Ni_{0.2}Fe₂O₄—N/C | 0.1M Na₂SO₄ | 15.35/−0.7 | 52.56/−0.8 | |
| | 0.1M Na₂SO₄ | | | |

*Its unit is μg h⁻¹ cm⁻²_{cat};

TABLE 6
Comparison of CH₄ oxidation performance at 0.8 V vs Ag/AgCl
for 2 h with or without N₂ gas flow in the cathode chamber.

| | Methanol | | 2-propanol | | Current |
|---|---|---|---|---|---|
| NRR | yield¹ | Its FE | yield¹ | Its FE | density² |
| Yes | 1925.4 | 9.03% | 398.1 | 5.59% | 4.1 |
| No | 722.6 | 3.76% | 306.4 | 4.79% | 2.9 |

¹Unit: mmol g_{cat}⁻¹ h⁻¹,
²Unit: mA cm⁻²

TABLE 7
Comparison of the NRR performance at −0.8 V vs
Ag/AgCl for 2 h with or without CH₄ gas in the anode.

| | | | | | Current |
|---|---|---|---|---|---|
| | Ammonia yield | Its | Hydrazine yield | Its | density |
| DMC | (μg h⁻¹ mg⁻¹_{cat}.) | FE | (μg h⁻¹ mg⁻¹_{cat}.) | FE | (mA cm⁻²) |
| Yes | 10.69 | 5.18% | 0 | 0 | 1.23 |
| No | 6.73 | 4.67% | 0 | 0 | 0.84 |

TABLE 8
Summaries of electrocatalytic CH₄ oxidation systems at room temperature.

| | | | Product Yield | |
|---|---|---|---|---|
| | | Main | (^{a}mmol g−1 h⁻¹/^{b}mg | |
| Catalyst | Potential | Product | mL⁻¹ h⁻¹) | Reference |
| TiO₂-ALD | 0.6 V vs. | CO | — | ²¹ |
| | RHE | | | |
| NiO/Ni | 1.4 V vs. | CH₃CH₂OH | ^{a}0.025 | ²² |
| | RHE | | | |
| NiO/Ni hollow | 1.46 V vs. | CH₃CH₂OH | — | ²³ |
| fiber | RHE | | | |
| NiO/ZrO₂ | 2.0 V vs. | CO | — | ²⁴ |
| | SCE | | | |
| ZrO₂/NiCo₂O₄ | 2.0 V vs. | CH₃CH₂CH₂OH, | ^{a}2.595 | ²⁵ |
| | Pt | CH₃CH(OH)CH₃ | | |
| ZrO₂/Co₃O₄ | 2.0 V vs. | CH₃CH₂CH₂OH, | ^{b}0.22 | ²⁶ |
| | Pt | CH₃CH(OH)CH₃ | | |
| ZrO₂ NTs/Co₃O₄ | 1.6 V vs. | CH₃CH₂CH₂OH, | ^{a}9.36 | ²⁷ |
| | RHE | CH₃CH(OH)CH₃ | | |
| | | CH₃CH₂OH | | |
| ZrO₂/CuOₓ | 2.2 V vs. | CH₃CH₂CH₂OH, | ^{b}0.23 | ²⁸ |
| | RHE | CH₃CH(OH)CH₃ | | |
| CuO/CeO₂ | 1.5 V vs. | CH₃OH | ^{a}0.753 | ²⁹ |
| | Pt | | | |
| Co_{0.6}Ni_{0.4}Fe₂O₄—N/C- | 0.8 V vs. | CH₃ OH | ^{a}1029/^{b}0.08 | |
| without NRR | Ag/AgCl | CH₃CH(OH)CH₃ | | |
| Co_{0.6}Ni_{0.4}Fe₂O₄—N/C | 1.1 V vs. | CH₃OH | ^{a}7273.8/^{b}0.74 | |
| | Ag/AgCl | CH₃CH(OH)CH₃ | | |
| Co_{0.6}Ni_{0.4}Fe₂O₄—N/C | 0.8 V vs. | CH₃OH | ^{a}2323.5/^{b}0.24 | |
| | Ag/AgCl | CH₃CH(OH)CH₃ | | |

1. An electrochemical catalyst, comprising:
(i) a trimetallic oxide of the formula
Co₁₋ₓNiₓFe₂O₄
wherein the catalyst is in the form of nano-cubes
and x is an integer between 0.1 and 0.9; and
(ii) carbon.

2. The electrochemical catalyst of claim 1, wherein the trimetallic oxide is Co_{0.8}Ni_{0.2}Fe₂O₄.

3. The electrochemical catalyst of claim 1, wherein the trimetallic oxide is Co_{0.6}Ni_{0.4}Fe₂O₄.

4. The electrochemical catalyst of claim 1, wherein the catalyst has XRD peaks of 18.28°, 26.15°, 35.69° and 43.36°.

5. The electrochemical catalyst claim 1, wherein x is an integer between 0.01 and 0.99.

6. The electrochemical catalyst of claim 5, wherein x is about 0.20, about 0.40, about 0.60, or about 0.80.

7. The electrochemical catalyst of claim 1, wherein the carbon is elemental carbon.

8. The electrochemical catalyst of claim 7, wherein the elemental carbon is graphite or graphene.

9. The electrochemical catalyst of claim 1, wherein the carbon is in the form of a layer adjacent to the nano-cube.

10. The electrochemical catalyst of claim 9, wherein the dimensions of the nanocubes with the adjacent carbon layer is between 10 nm and 1000 nm

11. The electrochemical catalyst of claim 10, wherein the dimensions of the nanocubes with the adjacent carbon layer is between 500 nm and 700 nm.

12. The electrochemical catalyst of claim 11, wherein the dimensions of the nanocubes with the adjacent carbon layer is between 600 nm and 700 nm.

13. The electrochemical catalyst of claim 12, wherein the dimensions of the nanocubes with the adjacent carbon layer is between 640 nm.

14. A method for preparing methanol from methane in an electrochemical process, the process comprising;
(e) introducing methane into an anode chamber of an electrochemical reactor, wherein the anode chamber comprises an anode comprising the electrochemical catalyst of claim 1;
(f) introducing a catholyte into a cathode chamber of the electrochemical reactor, wherein the cathode chamber comprises a cathode;
(g) introducing a voltage across the anode and the cathode, whereby at least a portion of the methane is oxidized to methanol; and
(h) collecting the methanol from the anode chamber.

15. The method according to claim 14, wherein the process further produces isopropanol.

16. The method according to claim 14, wherein the electrochemical catalyst is Co_{0.6}Ni_{0.4}Fe₂O₄.

17. The method according to claim 14, wherein the applied potential is between 0.2V and 2.5V versus Ag/AgCl.

18. A method for preparing ammonia from nitrogen gas (N₂) in an electrochemical process, the process comprising;
(e) introducing ammonia into a cathode chamber of an electrochemical reactor, wherein the cathode chamber comprises a cathode comprising the electrochemical catalyst of claim 1;
(f) introducing an anolyte into am anode chamber of the electrochemical reactor, wherein the anode chamber comprises an anode;
(g) introducing a voltage across the anode and the cathode, whereby at least a portion of the nitrogen gas is reduced to ammonia; and
(h) collecting the ammonia from the cathode chamber.

19. The method according to claim 18, wherein the electrochemical catalyst is Co_{0.8}Ni_{0.2}Fe₂O₄.

20. The method according to claim 18, wherein the applied potential is between 0.0 V and −2.0 V versus Ag/AgCl.

21. A method for preparing methanol from methane and ammonia from nitrogen gas in an electrochemical process, the process comprising;
(e) introducing methane into an anode chamber of an electrochemical reactor, wherein the anode chamber comprises an anode comprising the electrochemical catalyst of claim 1;
(f) introducing ammonia into a cathode chamber of an electrochemical reactor, wherein the cathode chamber comprises a cathode comprising the electrochemical catalyst of claim 1;
(g) introducing a voltage across the anode and the cathode, whereby at least a portion of the methane in the anode chamber is oxidized to methanol and at least a portion of the nitrogen gas is reduced to ammonia in the cathode chamber; and
(h) collecting the methanol from the anode chamber and the ammonia from the cathode chamber.

22. The method according to claim 21, wherein the electrochemical catalyst in the anode chamber is Co_{0.6}Ni_{0.4}Fe₂O₄.

23. The method according to claim 21, wherein the electrochemical catalyst in the cathode chamber is Co_{0.8}Ni_{0.2}Fe₂O₄.
